(19) United States
(12) Patent Application Publication
(10) Pub. No.: US 2024/0344586 A1
(43) Pub. Date: Oct. 17, 2024

(54) SHOCK ABSORBER

(71) Applicant: Hitachi Astemo, Ltd., Hitachinaka-shi, Ibaraki (JP)

(72) Inventor: Mikio YAMASHITA, Hitachinaka-shi (JP)

(21) Appl. No.: 18/682,969

(22) PCT Filed: Jun. 29, 2022
(86) PCT No.: PCT/JP2022/025986

§ 371 Date: Feb. 12, 2024

(30) Foreign Application Priority Data
Sep. 8, 2021 (JP) 2021-146223

(51) Int. Cl. F16F 9/512; F16F 9/348

(52) U.S. Cl. CPC F16F 9/5126; F16F 9/348

(57) ABSTRACT

The shock absorber includes a cylinder, a piston, a first passage through which a flow of the working fluid occurs due to movement of the piston in one direction, a first damping valve providing resistance to a flow of the working fluid from a chamber on an upstream side to a chamber on a downstream side of the first passage, a back pressure chamber causing an internal pressure to act on the first damping valve in a valve closing direction, a bottomed cylindrical case member having an opening at one end, the first damping valve disposed in the opening, and the back pressure chamber formed therein, a second passage introducing the working fluid into the back pressure chamber from the chamber on the upstream side, a second damping valve seated on a first seat part formed on a bottom portion of the case member.

### TECHNICAL FIELD

The present invention relates to a shock absorber.

Priority is claimed on Japanese Patent Application No. 2021-146223 filed on Sep. 8, 2021, the content of which is incorporated herein by reference.

### BACKGROUND ART

There is a shock absorber in which a damping valve that opens when a piston moves includes a mechanism that causes a pressure from a chamber having a high pressure to act in a valve closing direction as a back pressure (see, for example, Patent Document 1).

### CITATION LIST

### Patent Document

[Patent Document 1]

Japanese Patent No. 6722683

### SUMMARY OF INVENTION

### Technical Problem

There is a demand for reducing costs in shock absorbers.

Therefore, an objective of the present invention is to provide a shock absorber capable of reducing costs.

### Solution to Problem

A shock absorber according to one aspect of the present invention includes a cylinder in which a working fluid is sealed, a piston fitted in the cylinder and partitioning an inside of the cylinder into two chambers, a first passage through which a flow of the working fluid occurs due to movement of the piston in one direction, a first damping valve providing resistance to a flow of the working fluid from a chamber on an upstream side to a chamber on a downstream side of the first passage, a back pressure chamber causing an internal pressure to act on the first damping valve in a valve closing direction, a bottomed cylindrical case member having an opening at one end, the first damping valve disposed in the opening, and the back pressure chamber formed therein, a second passage introducing the working fluid into the back pressure chamber from the chamber on the upstream side, a second damping valve seated on a first seat part formed on a bottom portion of the case member and configured to open due to a pressure of the back pressure chamber to provide resistance to a flow of the working fluid toward the chamber on the downstream side, and a third damping valve seated on a second seat part formed on the bottom portion of the case member to have a diameter larger than that of the first seat part and configured to open with the first damping valve closed in a region at which a piston speed is low.

### Advantageous Effects of Invention

According to the shock absorber of the aspect described above, it is possible to reduce costs.

### BRIEF DESCRIPTION OF DRAWINGS

FIG. 1 is a view illustrating a shock absorber of an embodiment according to the present invention, and is a cross-sectional view seen in a cross section including a central axis line CL.

FIG. 2 is a partial cross-sectional view illustrating a part A in FIG. 1.

FIG. 3 is a plan view illustrating a third damping valve of the shock absorber of the embodiment according to the present invention.

FIG. 4 is a hydraulic circuit diagram showing a configuration of a main part of the shock absorber of the embodiment according to the present invention.

FIG. 5 is a partial cross-sectional view illustrating a flow of an oil fluid in the part A of FIG. 1.

FIG. 6 is a partial cross-sectional view illustrating a flow of the oil fluid in the part A of FIG. 1.

FIG. 7 is a partial cross-sectional view illustrating a flow of the oil fluid in the part A of FIG. 1.

FIG. 8 is a partial cross-sectional view illustrating a flow of the oil fluid in the part A of FIG. 1.

FIG. 9 is a partial cross-sectional view illustrating a flow of the oil fluid in the part A of FIG. 1.

FIG. 10 is a partial cross-sectional view illustrating a flow of the oil fluid in the part A of FIG. 1.

FIG. 11 is a partial cross-sectional view illustrating a flow of the oil fluid in the part A of FIG. 1.

FIG. 12 is a characteristics diagram showing damping force characteristics according to configurations of the main part of the shock absorber of the embodiment according to the present invention.

### DESCRIPTION OF EMBODIMENTS

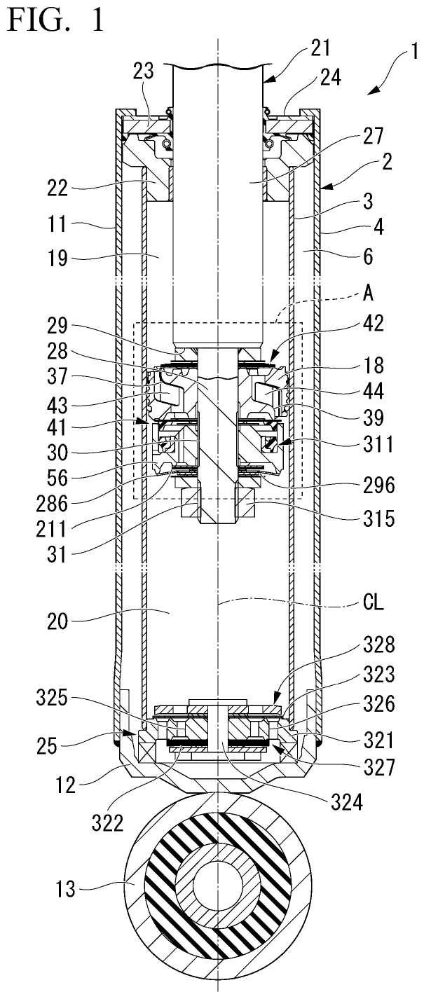

A shock absorber of the present embodiment will be described below with reference to the drawings. Further, in the following, for convenience of explanation, an upper side of the paper surface in FIGS. 1, 2, and 5 to 11 will be referred to using “upper,” and a lower side of the paper surface in FIGS. 1, 2, and 5 to 11 will be referred to using “lower”.

As illustrated in FIG. 1, a shock absorber 1 of the embodiment is a dual-tube type hydraulic shock absorber. The shock absorber 1 is used in suspension devices of vehicles. The shock absorber 1 includes a cylinder 2 in which an oil fluid (not illustrated) is sealed as a working fluid. The cylinder 2 includes an inner cylinder 3 and an outer cylinder 4. The inner cylinder 3 has a cylindrical shape. The outer cylinder 4 has a bottomed cylindrical shape. The outer cylinder 4 has an inner diameter larger than an outer diameter of the inner cylinder 3. The inner cylinder 3 is disposed inside the outer cylinder 4. A central axis of the inner cylinder 3 and a central axis of the outer cylinder 4 coincide with each other. A reservoir chamber 6 is provided between the inner cylinder 3 and the outer cylinder 4.

The outer cylinder 4 includes a barrel member 11 and a bottom member 12. The barrel member 11 has a cylindrical shape. The bottom member 12 has a bottomed cylindrical shape. The bottom member 12 is fitted to a lower side of the barrel member 11 and fixed by welding. The bottom member 12 closes a lower portion of the barrel member 11. A mounting eye 13 is fixed to the bottom member 12 on an outer side opposite to the barrel member 11 in an axial direction thereof.

The shock absorber 1 includes a piston 18. The piston 18 is slidably fitted into the inner cylinder 3 of the cylinder 2. The piston 18 partitions the inside of the inner cylinder 3 into two chambers, an upper chamber 19 and a lower chamber 20. In an axial direction of the cylinder 2, the upper chamber 19 is on a side opposite to the bottom member 12 with respect to the piston 18. In the axial direction of the cylinder 2, the lower chamber 20 is on the bottom member 12 side with respect to the piston 18. An oil fluid is sealed in the upper chamber 19 and the lower chamber 20 in the inner cylinder 3 as a working fluid. An oil fluid and a gas are sealed in the reservoir chamber 6 between the inner cylinder 3 and the outer cylinder 4 as a working fluid.

The shock absorber 1 includes a piston rod 21. One end side of the piston rod 21 in an axial direction thereof is disposed inside the inner cylinder 3 of the cylinder 2. This one end portion of the piston rod 21 is connected to the piston 18. A side of the other end portion of the piston rod 21 on a side opposite to the one end portion in the axial direction extends from the cylinder 2 to the outside of the cylinder 2. The piston 18 is fixed to the piston rod 21. Therefore, the piston 18 and the piston rod 21 move together. In the shock absorber 1, a stroke in which the piston rod 21 moves in a direction to increase an amount of protrusion from the cylinder 2 is an extension stroke in which the entire length increases. In the shock absorber 1, a stroke in which the piston rod 21 moves in a direction to decrease an amount of protrusion from the cylinder 2 is a compression stroke in which the entire length decreases. In the shock absorber 1, the piston 18 moves to the upper chamber 19 side during the extension stroke. In the shock absorber 1, the piston 18 moves to the lower chamber 20 side during the compression stroke.

A rod guide 22 is fitted to an upper end opening side of the inner cylinder 3 and an upper end opening side of the outer cylinder 4. A seal member 23 is fitted to the outer cylinder 4 on an upper side of the rod guide 22. A disc 24 is fitted into the outer cylinder 4 on an upper side of the seal member 23. Both the rod guide 22 and the seal member 23 have an annular shape. The disc 24 has a bored circular flat plate shape. The disc 24 is in contact with a portion on an outer circumferential side of the seal member 23. The piston rod 21 slides with respect to the rod guide 22 and the seal member 23 in an axial direction of these. The piston rod 21 extends from the inside of the cylinder 2 to the outside of the cylinder 2 with respect to the seal member 23.

The rod guide 22 restricts movement of the piston rod 21 in a radial direction with respect to the inner cylinder 3 and outer cylinder 4 of the cylinder 2. The piston rod 21 is fitted in the rod guide 22, and the piston 18 is fitted in the inner cylinder 3. Thereby, a central axis of the piston rod 21 and a central axis of the cylinder 2 coincide with each other. The rod guide 22 supports the piston rod 21 to be movable in an axial direction of the piston rod 21. The seal member 23 has an outer circumferential portion in close contact with the outer cylinder 4. The seal member 23 has an inner circumferential portion in close contact with an outer circumferential portion of the piston rod 21. The piston rod 21 moves in an axial direction of the seal member 23 with respect to the seal member 23. The seal member 23 curbs the oil fluid in the inner cylinder 3 and the high-pressure gas and the oil fluid in the reservoir chamber 6 leaking to the outside.

An outer circumferential portion of the rod guide 22 has a larger diameter at an upper portion than at a lower portion. The rod guide 22 is fitted to an inner circumferential portion of an upper end of the inner cylinder 3 at the lower portion with the smaller diameter. The rod guide 22 is fitted to an upper inner circumferential portion of the outer cylinder 4 at the upper portion with the larger diameter. A base valve 25 is installed on the bottom member 12 of the outer cylinder 4. The base valve 25 is positioned in the radial direction with respect to the outer cylinder 4. The base valve 25 partitions the lower chamber 20 and the reservoir chamber 6. An inner circumferential portion of a lower end of the inner cylinder 3 is fitted to the base valve 25. An upper end portion of the outer cylinder 4 is swaged inward in the radial direction of the outer cylinder 4. The seal member 23, together with the disc 24, is fixed to the cylinder 2 by being sandwiched between the swaged portion and the rod guide 22.

The piston rod 21 includes a main shaft part 27 and a mounting shaft part 28. The mounting shaft part 28 has an outer diameter smaller than an outer diameter of the main shaft part 27. The mounting shaft part 28 is disposed inside the cylinder 2. The piston 18 is attached to the mounting shaft part 28. The main shaft part 27 includes a shaft step part 29. The shaft step part 29 is provided at an end portion of the main shaft part 27 on the mounting shaft part 28 side. The shaft step part 29 extends in a direction orthogonal to the central axis of the piston rod 21. A passage groove 30 is formed in the piston rod 21 on an outer circumferential portion of the mounting shaft part 28. The passage groove 30 extends in an axial direction of the mounting shaft part 28. A plurality of passage grooves 30 are formed at intervals in a circumferential direction of the mounting shaft part 28. A male screw 31 is formed on an outer circumferential portion of an end portion of the mounting shaft part 28 on a side opposite to the main shaft part 27 with respect to the passage grooves 30 in the axial direction of the mounting shaft part 28.

In the shock absorber 1, for example, a portion of the piston rod 21 protruding from the cylinder 2 is disposed at an upper portion and is connected to a vehicle body of a vehicle. At that time, the mounting eye 13 of the shock absorber 1 provided on the cylinder 2 side is disposed at a lower portion and is connected to a wheel side of the vehicle. Conversely, the cylinder 2 side of the shock absorber 1 may be connected to the vehicle body. In this case, the piston rod 21 of the shock absorber 1 is connected to the wheel side.

In the vehicle, the wheel vibrates with respect to the vehicle body as the vehicle travels. Then, in the shock absorber 1, positions of the cylinder 2 and the piston rod 21 change relative to each other according to the vibration. This change is suppressed by fluid resistance in a flow path provided in the shock absorber 1. As will be described below, the fluid resistance in the flow path provided in the shock absorber 1 is made to be different according to a speed or an amplitude of the vibration described above. When the shock absorber 1 suppresses the vibration, ride comfort of the vehicle is improved.

Also, in the vehicle, an inertial force or a centrifugal force generated in the vehicle body as the vehicle travels also acts between the cylinder 2 and the piston rod 21 in addition to the vibration generated by the wheel with respect to the vehicle body. For example, a centrifugal force is generated in the vehicle body when a traveling direction is changed by a steering wheel operation. Then, a force based on the centrifugal force acts between the cylinder 2 and the piston rod 21. As will be described below, the shock absorber 1 has satisfactory properties against vibration based on the force generated in the vehicle body as the vehicle travels. High traveling stability of the vehicle can be obtained by the shock absorber 1.

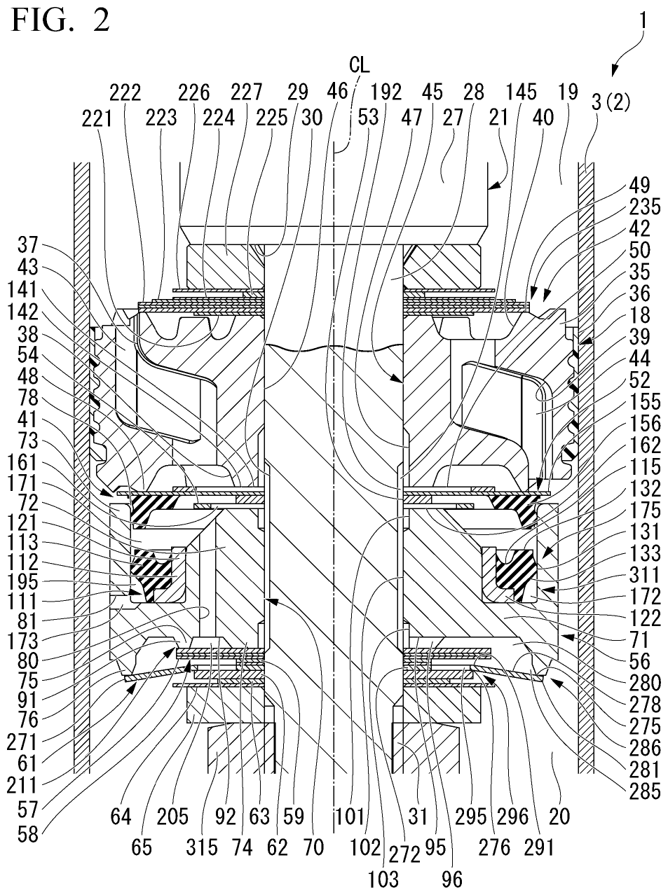

As illustrated in FIG. 2, the piston 18 includes a piston main body 35 and a slide member 36. The piston main body 35 is made of a metal and has an annular shape. The piston main body 35 of the piston 18 is fitted onto the mounting shaft part 28 of the piston rod 21. The slide member 36 is made of a synthetic resin and has an annular shape. The slide member 36 is integrally attached to an outer circumferential surface of the piston main body 35. The piston 18 slides with respect to the inner cylinder 3 with the slide member 36 in contact with the inner cylinder 3.

A passage hole 37, a passage groove 38, a passage hole 39, and a passage groove 40 are provided in the piston main body 35. The passage hole 37 penetrates the piston main body 35 in an axial direction of the piston main body 35. A plurality of passage holes 37 are formed in the piston main body 35 at intervals in a circumferential direction of the piston main body 35 (only one is illustrated in FIG. 2 because it is a cross section). The passage hole 39 penetrates the piston main body 35 in the axial direction of the piston main body 35. A plurality of passage holes 39 are formed in the piston main body 35 at intervals in the circumferential direction of the piston main body 35 (only one is illustrated in FIG. 2 because it is a cross section). In the piston main body 35, the passage holes 37 and the passage holes 39 are alternately formed one by one at a regular pitch in the circumferential direction of the piston main body 35.

The passage groove 38 is formed in the piston main body 35 in an annular shape in the circumferential direction of the piston main body 35. The passage groove 38 is formed at one end portion of the piston main body 35 in the axial direction. All the passage holes 37 open to the passage groove 38 at a side of the one end portion in the axial direction of the piston main body 35. The passage groove 40 is formed in the piston main body 35 in an annular shape in the circumferential direction of the piston main body 35. The passage groove 40 is formed at the other end portion on a side opposite to the passage groove 38 in the axial direction of the piston main body 35. All the passage holes 39 open to the passage groove 40 at end portions on a side opposite to the passage groove 38 in the axial direction of the piston main body 35. End portions of the plurality of passage holes 37 on a side opposite to the passage groove 38 in the axial direction of the piston main body 35 open to an outer side of the passage groove 40 in a radial direction of the piston main body 35. End portions of the plurality of passage holes 39 on a side opposite to the passage groove 40 in the axial direction of the piston main body 35 open to an outer side of the passage groove 38 in the radial direction of the piston main body 35. In the piston 18, the inside of the plurality of passage holes 37 and the inside of the passage groove 38 form a first passage 43. In the piston 18, the inside of the plurality of passage holes 39 and the inside of the passage groove 40 form a first passage 44.

A first damping force generation mechanism 41 is provided in the first passage 43. The first damping force generation mechanism 41 opens and closes the first passage 43 to generate a damping force. The first damping force generation mechanism 41 is disposed on the lower chamber 20 side in an axial direction of the piston 18 and is attached to the piston rod 21. Thereby, the first passage 43 serves as a passage through which the oil fluid flows from the upper chamber 19 on one side toward the lower chamber 20 on the other side due to movement of the piston 18 to the upper chamber 19 side which is one direction. That is, the first passage 43 serves as a passage through which the oil fluid flows from the upper chamber 19 toward the lower chamber 20 during the extension stroke. The first damping force generation mechanism 41 is an extension-side damping force generation mechanism that generates a damping force by suppressing a flow of the oil fluid from the first passage 43 to the lower chamber 20 that occurs during the extension stroke.

A first damping force generation mechanism 42 is provided in the first passage 44. The first damping force generation mechanism 42 opens and closes the first passage 44 to generate a damping force. The first damping force generation mechanism 42 is disposed on the upper chamber 19 side in the axial direction of the piston 18, and is attached to the piston rod 21. Thereby, the first passage 44 serves as a passage through which the oil fluid flows from the lower chamber 20 toward the upper chamber 19 due to movement of the piston 18 to the lower chamber 20 side. That is, the first passage 44 serves as a passage through which the oil fluid flows from the lower chamber 20 toward the upper chamber 19 during the compression stroke. The first damping force generation mechanism 42 is a compression-side damping force generation mechanism that generates a damping force by suppressing a flow of the oil fluid from the first passage 44 to the upper chamber 19 that occurs during the compression stroke.

An insertion hole 45 is formed at a center of the piston main body 35 in the radial direction to penetrate the piston main body 35 in the axial direction. The mounting shaft part 28 of the piston rod 21 is inserted through the insertion hole 45. The insertion hole 45 has a small diameter hole portion 46 and a large diameter hole portion 47. The large diameter hole portion 47 has a diameter larger than that of the small diameter hole portion 46. The mounting shaft part 28 of the piston rod 21 is fitted in the small diameter hole portion 46 of the piston main body 35. In an axial direction of the insertion hole 45, the large diameter hole portion 47 is disposed on the lower chamber 20 side with respect to the small diameter hole portion 46. A passage inside the large diameter hole portion 47 of the piston 18 communicates with a passage inside the passage groove 30 of the piston rod 21.

A valve seat part 48 is formed at an end portion of the piston main body 35 on the lower chamber 20 side in the axial direction. The valve seat part 48 has an annular shape. The valve seat part 48 is disposed on an outer side with respect to an opening of the passage groove 38 on the lower chamber 20 side in the radial direction of the piston main body 35. The valve seat part 48 constitutes a part of the first damping force generation mechanism 41.

A valve seat part 49 is formed at an end portion of the piston main body 35 on the upper chamber 19 side in the axial direction. The valve seat part 49 has an annular shape. The valve seat part 49 is disposed on an outer side with respect to an opening of the passage groove 40 on the upper chamber 19 side in the radial direction of the piston main body 35. The valve seat part 49 constitutes a part of the first damping force generation mechanism 42.

In the piston main body 35, openings in all the passage holes 39 on the lower chamber 20 side are disposed on a side of the valve seat part 48 opposite to the passage groove 38 in the radial direction of the piston main body 35. In the piston main body 35, openings in all the passage holes 37 on the upper chamber 19 side are disposed on a side of the valve seat part 49 opposite to the passage groove 40 in the radial direction of the piston main body 35.

One disc 50, one first damping valve 52, one disc 53, one disc 54, one case member 56, a second damping valve 58 formed of a plurality of discs 57, a plurality of discs 59, one third damping valve 61, one support disc 62, one disc 63, one disc 64, and one annular member 65 are provided on the valve seat part 48 side in the axial direction of the piston 18 in order from the piston 18 side in the axial direction of the piston 18. The discs 50, 53, 54, 57, 59, 63, and 64, the third damping valve 61, the support disc 62, the case member 56, and the annular member 65 are all made of a metal. The discs 50, 53, 54, 57, 59, 63, and 64, the third damping valve 61, the support disc 62, and the annular member 65 are all formed in a bored circular flat plate shape each having a constant thickness before they are assembled to the piston rod 21. The mounting shaft part 28 of the piston rod 21 is fitted to an inner side of all the discs 50, 53, 54, 57, 59, 63, and 64, the third damping valve 61, the support disc 62, and the annular member 65. Both the first damping valve 52 and the case member 56 have an annular shape. The mounting shaft part 28 of the piston rod 21 is fitted to an inner side of both the first damping valve 52 and the case member 56.

The case member 56 has a bottomed cylindrical shape. The entire case member 56 is seamlessly and integrally formed by sintering. A through hole 70 is formed at a center of the case member 56 in the radial direction. The through hole 70 penetrates the case member 56 in an axial direction thereof. The case member 56 has a bottom portion 71, an inner cylindrical portion 72 (protruding portion), an outer cylindrical portion 73 (cylindrical portion), an inner seat part 74, a first seat part 75, and a second seat part 76.

The bottom portion 71 has a bored disc shape.

The inner cylindrical portion 72 has a cylindrical shape and is formed on an inner circumferential side of the bottom portion 71. The inner cylindrical portion 72 protrudes from a portion of the bottom portion 71 on the inner circumferential side to one side in the axial direction of the bottom portion 71. In other words, the inner cylindrical portion 72 is formed in the case member 56 on the inner circumferential side of the bottom portion 71. A passage hole 80 is formed in the inner cylindrical portion 72 on a radially outer side with respect to the through hole 70. The passage hole 80 penetrates the inner cylindrical portion 72 and the bottom portion 71 in an axial direction thereof. A plurality of passage holes 80 are provided at regular intervals in a circumferential direction of the inner cylindrical portion 72 (only one is illustrated in FIG. 2 because it is a cross section).

The outer cylindrical portion 73 has a cylindrical shape and is formed on an outer circumferential side of the bottom portion 71. The outer cylindrical portion 73 protrudes from a portion on the outer circumferential side of the bottom portion 71 to the same side as the inner cylindrical portion 72 in the axial direction of the bottom portion 71. A side of the outer cylindrical portion 73 opposite to the bottom portion 71 in the axial direction is an opening 78. In other words, the outer cylindrical portion 73 is formed on the outer circumferential side of the bottom portion 71 and has the opening 78. In other words, the case member 56 has a bottomed cylindrical shape having the opening 78 at one end in the axial direction. A passage hole 81 is formed in the case member 56 in the vicinity of a boundary between the outer cylindrical portion 73 and the bottom portion 71. The passage hole 81 penetrates the outer cylindrical portion 73 in a radial direction of the outer cylindrical portion 73.

The inner seat part 74 is formed on the inner circumferential side of the bottom portion 71. The inner seat part 74 has an annular shape. The inner seat part 74 protrudes from a portion on the inner circumferential side of the bottom portion 71 to a side opposite to the inner cylindrical portion 72 in the axial direction of the bottom portion 71.

The first seat part 75 is formed at an intermediate portion in a radial direction of the bottom portion 71. The first seat part 75 protrudes from the bottom portion 71 to the same side as the inner seat part 74 in the axial direction of the bottom portion 71 at an outer side in a radial direction of the inner seat part 74. The first seat part 75 is a petal-like deformed seat that is not circular. The first seat part 75 includes a plurality of seat forming parts 91 (only one is illustrated in FIG. 2 because it is a cross section). These seat forming parts 91 have the same shape and are disposed at regular intervals in a circumferential direction of the case member 56. The inner seat part 74 has an annular shape with a central axis of the case member 56 as a center. The plurality of seat forming parts 91 extend radially from the inner seat part 74. In an axial direction of the case member 56, a position of a distal end surface of the plurality of seat forming parts 91 on a side opposite to the bottom portion 71 is at the same position as a position of a distal end surface of the inner seat part 74 on a side opposite to the bottom portion 71.

A passage recessed part 92 is formed on an inner side of each of the seat forming parts 91. The passage recessed part 92 is formed to be surrounded by a part of the inner seat part 74 and the seat forming part 91. The passage recessed part 92 is recessed in the axial direction of the case member 56 from the distal end surface of the protruding side of the inner seat part 74 and the distal end surface of the protruding side of the seat forming part 91. A bottom surface of the passage recessed part 92 is formed of the bottom portion 71. The passage recessed part 92 is formed on an inner side of all the seat forming parts 91. The passage holes 80 of the inner cylindrical portion 72 open in the corresponding passage recessed parts 92, respectively.

The second seat part 76 is formed on the outer circumferential side of the bottom portion 71. The second seat part 76 is formed to have a larger diameter than the first seat part 75. The second seat part 76 protrudes from the bottom portion 71 to the same side as the first seat part 75 in the axial direction of the bottom portion 71 at an outer side in a radial direction of the first seat part 75. In the axial direction of the case member 56, a position of a distal end surface of the second seat part 76 on a side opposite to the bottom portion 71 is on a side opposite to the bottom portion 71 with respect to a position of a distal end surface of the first seat part 75 on a side opposite to the bottom portion 71. The second seat part 76 has an annular shape. The second seat part 76 surrounds the first seat part 75 from an outer side in the radial direction of the bottom portion 71.

A passage groove 95 penetrating the inner seat part 74 in the radial direction of the inner seat part 74 is formed in the inner seat part 74. The passage groove 95 is disposed between the seat forming part 91 and the seat forming part 91 adjacent to each other in a circumferential direction of the bottom portion 71. The passage groove 95 is formed by a coining. A passage inside the passage groove 95 serves as a throttle 96. The throttle 96 does not open into the passage recessed part 92.

The through hole 70 has a large diameter hole portion 101, a small diameter hole portion 102, and a large diameter hole portion 103. Both the large diameter hole portion 101 and the large diameter hole portion 103 have a diameter larger than that of the small diameter hole portion 102. The small diameter hole portion 102 is disposed at an intermediate position of the through hole 70 in the axial direction. The large diameter hole portion 101 is disposed at one end side of the through hole 70 in the axial direction. The large diameter hole portion 101 overlaps the inner cylindrical portion 72 in position in the axial direction of the case member 56. The large diameter hole portion 103 is disposed on the other end side opposite to the large diameter hole portion 101 in the axial direction of the through hole 70. The large diameter hole portion 103 overlaps the inner seat part 74 in position in the axial direction of the case member 56. The mounting shaft part 28 of the piston rod 21 is fitted in the small diameter hole portion 102 of the through hole 70. The large diameter hole portions 101 and 103 overlap the passage groove 30 of the piston rod 21 in position in the axial direction of the piston rod 21. In the case member 56, a passage in the large diameter hole portion 101 and a passage in the large diameter hole portion 103 communicate with a passage inside the passage groove 30 of the piston rod 21.

A partition member 111 is provided in the case member 56. The partition member 111 is disposed between the inner cylindrical portion 72 and the outer cylindrical portion 73 of the case member 56. The partition member 111 is formed of a metal ring 112 and a lip 113.

The metal ring 112 is made of a metal and has an annular shape. The metal ring 112 includes a fixing part 121 and a flange part 122. The fixing part 121 has a cylindrical shape. The flange part 122 extends from one end in an axial direction of the fixing part 121 to an outer side in a radial direction of the fixing part 121. The flange part 122 has a disc shape. The metal ring 112 is seamlessly and integrally formed by press-forming a single sheet of a plate material. A cross section of the metal ring 112 in a plane including a central axis thereof has an L shape.

The lip 113 is made of rubber having rubber elasticity and has an annular shape. The lip 113 is adhered to the fixing part 121 and the flange part 122 of the metal ring 112 by heat. Therefore, the lip 113 is integrally formed with the metal ring 112. The lip 113 is adhered to an outer circumferential surface of the fixing part 121, an end surface of the flange part 122 on the fixing part 121 side in the axial direction, and an outer circumferential surface of the flange part 122.

A recessed part 115 is formed in the lip 113 on the fixing part 121 side in the radial direction. The recessed part 115 is recessed to the flange part 122 side in an axial direction of the lip 113 from an end surface of the lip 113 on a side opposite to the flange part 122 in the axial direction. The recessed part 115 is formed over the entire circumference of the lip 113. The recessed part 115 has an annular shape. An outer diameter of an outer circumferential portion of the lip 113 on both sides in the axial direction of the lip 113 is smaller than an outer diameter of an intermediate portion of the lip 113 in the axial direction.

The partition member 111 is fixed by the fixing part 121 of the metal ring 112 being press-fitted into an outer circumferential portion of the inner cylindrical portion 72 of the case member 56 with a press-fit allowance. In this state, the flange part 122 of the metal ring 112 is in contact with the bottom portion 71 of the case member 56. Also, in this state, an outer diameter side of the lip 113 is in contact with an inner circumferential portion of the outer cylindrical portion 73 of the case member 56 with a fastening allowance over the entire circumference. Also, in this state, an end surface of the lip 113 on the bottom portion 71 side in the axial direction is in contact with the bottom portion 71. An outer diameter of the end surface of the lip 113 on the bottom portion 71 side is smaller than an inner diameter of the outer cylindrical portion 73. The lip 113 does not close the passage hole 81 of the case member 56 at the end surface on the bottom portion 71 side.

An outer diameter portion of the lip 113 in contact with the inner circumferential portion of the outer cylindrical portion 73 serves as a seal portion 131. The seal portion 131 is disposed at an intermediate portion of the lip 113 in the axial direction. Portions of the lip 113 on both sides of the seal portion 131 in the axial direction are separated from the inner circumferential portion of the outer cylindrical portion 73 in the radial direction. A portion of the lip 113 on a side opposite to the bottom portion 71 with respect to the seal portion 131 in the axial direction serves as a first pressure receiving portion 132. A portion of the lip 113 on the bottom portion 71 side of the seal portion 131 in the axial direction serves as a second pressure receiving portion 133.

The disc 50 has an outer diameter smaller than an inner diameter of the valve seat part 48 of the piston 18. A notch 141 is formed in the disc 50. The notch 141 extends outward in the radial direction from an inner circumferential edge portion of the disc 50 fitted onto the mounting shaft part 28. The inside of the notch 141 serves as a throttle 142. The throttle 142 is in constant communication with the first passage 43 of the piston 18. Here, the passage inside the large diameter hole portion 47 of the piston 18, the passages inside the large diameter hole portions 101 and 103 of the case member 56, and the passage inside the passage groove 30 of the piston rod 21 form a rod chamber 145. The first passage 43 is in constant communication with the rod chamber 145 via the throttle 142 in the notch 141.

The first damping valve 52 is formed of a disc 155 and a seal member 156.

The disc 155 is made of a metal and has a bored circular flat plate shape. An outer diameter of the disc 155 is larger than an outer diameter of the valve seat part 48 of the piston 18. The mounting shaft part 28 of the piston rod 21 is fitted to an inner circumferential side of the disc 155. In the first damping valve 52, the disc 155 comes into contact with the valve seat part 48. The first damping valve 52 opens and closes an opening on the lower chamber 20 side of the first passage 43 formed in the piston 18 when the disc 155 is separated from and comes into contact with the valve seat part 48.

The seal member 156 is made of rubber and is adhered to the disc 155. The seal member 156 is fixed to an outer circumferential side of the disc 155 and has an annular shape. The seal member 156 is fitted in a liquid-tight manner to an inner circumferential surface of the outer cylindrical portion 73 of the case member 56 on the opening 78 side over the entire circumference. The seal member 156 is slidable with respect to the inner circumferential surface of the outer cylindrical portion 73 in the axial direction. The seal member 156 constantly seals a gap between the first damping valve 52 and the outer cylindrical portion 73. The first damping valve 52 is disposed in the opening 78 of the case member 56.

The disc 53 has an outer diameter smaller than a minimum inner diameter of the seal member 156. The disc 54 has an outer diameter larger than the outer diameter of the disc 53 and smaller than the minimum inner diameter of the seal member 156. A notch 161 is formed in the disc 54. The notch 161 extends outward in the radial direction from an inner circumferential edge portion of the disc 54 fitted to the mounting shaft part 28. The inside of the notch 161 serves as a throttle 162. The notch 162 is in constant communication with the rod chamber 145.

With the lip 113 of the partition member 111 in contact with the inner circumferential surface of the outer cylindrical portion 73 at the seal portion 131, a back pressure chamber 171 is formed between the inner cylindrical portion 72 and the outer cylindrical portion 73 of the case member 56, the first damping valve 52 and the discs 53 and 54, and the partition member 111. The back pressure chamber 171 is formed inside the bottomed cylindrical case member 56. The back pressure chamber 171 is in constant communication with the rod chamber 145 via the throttle 162. Also, in this state, a variable chamber 172 (separate chamber) is formed between the outer cylindrical portion 73 and the bottom portion 71 of the case member 56 and the partition member 111. The variable chamber 172 is in constant communication with the lower chamber 20 via a passage portion 173 inside the passage hole 81. In this way, the case member 56 forms the back pressure chamber 171 and the variable chamber 172 on an inner side thereof with the first damping valve 52, the discs 53 and 54, and the partition member 111. The partition member 111 is provided inside the case member 56 and partitions the inside of the case member 56 into the back pressure chamber 171 and the variable chamber 172.

The partition member 111 blocks a flow of the oil fluid between the back pressure chamber 171 and the variable chamber 172 when the lip 113 thereof is in contact with the inner circumferential surface of the outer cylindrical portion 73 at the seal portion 131. Also, the partition member 111 allows the oil fluid to flow between the variable chamber 172 and the back pressure chamber 171 when the lip 113 thereof is separated from the inner circumferential surface of the outer cylindrical portion 73. Here, when a pressure on the variable chamber 172 side that the second pressure receiving portion 133 receives becomes higher than a pressure on the back pressure chamber 171 side that the first pressure receiving portion 132 receives by a predetermined value or more, the lip 113 of the partition member 111 allows a flow of the oil fluid from the variable chamber 172 to the back pressure chamber 171. In a state in which the pressure on the back pressure chamber 171 side that the first pressure receiving portion 132 receives is higher than the pressure on the variable chamber 172 side that the second pressure receiving portion 133 receives, the lip 113 of the partition member 111 restricts a flow of the oil fluid from the back pressure chamber 171 to the variable chamber 172. Therefore, the lip 113 of the partition member 111 and the outer cylindrical portion 73 of the case member 56 constitute a check valve 175. Between the back pressure chamber 171 and the variable chamber 172, the check valve 175 restricts a flow of oil fluid in one direction from the back pressure chamber 171 side to the variable chamber 172 side while allowing a flow of the oil fluid in the other direction from the variable chamber 172 side to the back pressure chamber 171 side.

The disc 155 of the first damping valve 52 can be seated on the valve seat part 48 of the piston 18. The first damping valve 52 is provided in the first passage 43 formed in the piston 18 and suppresses a flow of the oil fluid caused by sliding of the piston 18 to the extension side to generate a damping force. The first damping valve 52, together with the valve seat part 48 of the piston 18, constitutes the first damping force generation mechanism 41. The first damping valve 52 opens when the disc 155 thereof is separated from the valve seat part 48. Then, the first damping valve 52 causes the oil fluid from the first passage 43 to flow into the lower chamber 20 through a space between itself and the valve seat part 48. The first passage 43 serves as an extension-side passage through which the oil fluid in the upper chamber 19 flows due to movement of the piston 18 to the upper chamber 19 side. The first passage 43 serves as an extension-side passage through which the oil fluid as a working fluid flows from the upper chamber 19 on one side to the lower chamber 20 on the other side during the extension stroke. The first damping force generation mechanism 41 on the extension side constituted by the valve seat part 48 and the first damping valve 52 is provided in the first passage 43 and generates a damping force by opening and closing the first passage 43 with the first damping valve 52 to suppress a flow of oil fluid. The first damping force generation mechanism 41 is provided in the first passage 43 and changes a flow path area due to a flow of the oil fluid serving as a working fluid.

In the first damping force generation mechanism 41 on the extension side, a fixed orifice that allows communication between the upper chamber 19 and the lower chamber 20 is not formed in either the valve seat part 48 or the first damping valve 52 that comes into contact with the valve seat part 48 even when they are in a contact state. That is, the first damping force generation mechanism 41 on the extension side does not allow communication between the upper chamber 19 and the lower chamber 20 in a state in which the valve seat part 48 and the first damping valve 52 are in contact with each other over the entire circumference. In other words, the first passage 43 does not include a fixed orifice formed to allow constant communication between the upper chamber 19 and the lower chamber 20. The first passage 43 is not a passage that allows constant communication between the upper chamber 19 and the lower chamber 20.

The first passage 43 is a passage on an upstream side of the first damping valve 52 in a flow direction of the oil fluid during the extension stroke.

The throttle 142, the rod chamber 145, and the throttle 162 constitute a second passage 192. The second passage 192 communicates with the first passage 43 and the back pressure chamber 171. The second passage 192 introduces the oil fluid into the back pressure chamber 171 from the upper chamber 19 on an upstream side of the back pressure chamber 171 through the first passage 43 during the extension stroke.

The passage portion 173 inside the passage hole 81 of the case member 56 communicates with the lower chamber 20. The lower chamber 20 is on a downstream side of the first damping valve 52 in the flow direction of the oil fluid during the extension stroke. The passage portion 173 of the case member 56 communicates with the variable chamber 172.

The back pressure chamber 171 and the variable chamber 172 constitute a passage chamber 195 that allows communication between the second passage 192 and the passage portion 173. The partition member 111 is provided in the passage chamber 195. The check valve 175 is also provided in the passage chamber 195. The seal portion 131 of the lip 113 of the partition member 111 suppresses a flow of the oil fluid from the second passage 192 to the passage portion 173 via the passage chamber 195. The first pressure receiving portion 132 of the lip 113 receives a pressure on the second passage 192 side. The second pressure receiving portion 133 of the lip 113 receives a pressure on the passage portion 173 side. The lip 113 allows a flow of the oil fluid from the passage portion 173 to the second passage 192 via the passage chamber 195 due to the pressure received by the second pressure receiving portion 133. The check valve 175 restricts a flow of the oil fluid from the upper chamber 19, the first passage 43, the second passage 192, and the back pressure chamber 171 to the variable chamber 172, the passage portion 173, and the lower chamber 20. The check valve 175 allows a flow of the oil fluid from the lower chamber 20, the passage portion 173, and the variable chamber 172 to the back pressure chamber 171, the second passage 192, the first passage 43, and the upper chamber 19.

The back pressure chamber 171 communicates with the second passage 192.

The back pressure chamber 171 causes an internal pressure to act on the first damping valve 52 in a direction of the piston 18, that is, in a valve closing direction in which the disc 155 is seated on the valve seat part 48. In other words, the back pressure chamber 171 causes the first damping valve 52 to generate a force in a direction of reducing a flow path area thereof due to the internal pressure. An opening of the first damping valve 52 is adjusted by the pressure in the back pressure chamber 171. That is, the opening of the first damping force generation mechanism 41 including the first damping valve 52 is adjusted by the pressure in the back pressure chamber 171.

The plurality of discs 57 have the same outer diameter and have an outer diameter slightly larger than a maximum outer diameter of the distal end surface of the first seat part 75. The plurality of discs 57 constitute the second damping valve 58 that can be separated from and seated on the first seat part 75. A passage in the passage hole 80 of the case member 56 and a passage in the passage recessed part 92 form a bypass passage 205. The bypass passage 205 allows the second passage 192 and the back pressure chamber 171 to communicate with the lower chamber 20. The first seat part 75 and the second damping valve 58 are provided in the bypass passage 205 and constitute a second damping force generation mechanism 211 that opens and closes the bypass passage 205.

The second damping valve 58 of the second damping force generation mechanism 211 is seated on the first seat part 75. During the extension stroke, the second damping valve 58 opens due to the pressure in the back pressure chamber 171 and provides resistance to a flow of the oil fluid from the back pressure chamber 171 to the lower chamber 20 on a downstream side. At that time, the bypass passage 205 causes the oil fluid on the upper chamber 19 side to flow to the lower chamber 20 side via the first passage 43, the second passage 192, and the back pressure chamber 171. The second damping force generation mechanism 211 allows the second passage 192 and the back pressure chamber 171 to communicate with the lower chamber 20 side via the bypass passage 205 when the second damping valve 58 is separated from the first seat part 75. At that time, the second damping force generation mechanism 211 generates a damping force by suppressing a flow of the oil fluid between the second passage 192 and the lower chamber 20. The second damping force generation mechanism 211 is an extension-side damping force generation mechanism provided in the bypass passage 205 and generating a damping force due to a flow of the oil fluid.

In the second damping force generation mechanism 211 on the extension side, a fixed orifice that allows the bypass passage 205 to communicate with the lower chamber 20 side is not formed in either the first seat part 75 and the second damping valve 58 that comes into contact with the first seat part 75 even when they are in a contact state.

An outer diameter of the disc 59 is equal to an outer diameter of the inner seat part 74.

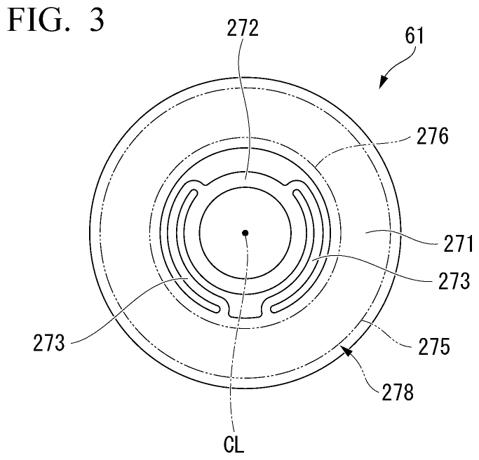

The third damping valve 61 is bendable. The third damping valve 61 has a flat plate shape in its entirety in a natural state before being incorporated into the shock absorber 1. As illustrated in FIG. 3, the third damping valve 61 in a natural state includes an outer annular portion 271, an inner annular portion 272, and a plurality of, specifically two, support portions 273. The outer annular portion 271 has a bored disc shape. The inner annular portion 272 has a bored disc shape. The inner annular portion 272 has an outer diameter smaller than an inner diameter of the outer annular portion 271. The inner annular portion 272 is disposed inside the outer annular portion 271. The plurality of support portions 273 connect the outer annular portion 271 and the inner annular portion 272. There is a space between the outer annular portion 271 and the inner annular portion 272 except for the plurality of support portions 273. The third damping valve 61 has a mirror-symmetrical shape.

The outer annular portion 271 has an outer circumferential surface and an inner circumferential surface that are both circular and concentrically disposed. In other words, the outer annular portion 271 has an annular shape having a constant width in the radial direction. The inner annular portion 272 also has an outer circumferential surface and an inner circumferential surface that are both circular and concentrically disposed. In other words, the inner annular portion 272 also has an annular shape having a constant width in the radial direction. The plurality of support portions 273 are disposed between the inner annular portion 272 and the outer annular portion 271. The plurality of support portions 273 all extend in a circumferential direction of the inner annular portion 272 and the outer annular portion 271. All the plurality of support portions 273 connect the outer circumferential surface of the inner annular portion 272 and the inner circumferential surface of the outer annular portion 271. The plurality of support portions 273 concentrically support the outer annular portion 271 on the inner annular portion 272. The plurality of support portions 273 have a lower rigidity than the inner annular portion 272 and the outer annular portion 271.

As illustrated in FIG. 2, the mounting shaft part 28 of the piston rod 21 is fitted to an inner side of the inner annular portion 272. The inner annular portion 272 has an outer diameter equal to the outer diameter of the disc 59. The inner annular portion 272 is positioned in the radial direction with respect to the piston rod 21 when the mounting shaft part 28 is fitted therein.

The outer annular portion 271 has an outer diameter smaller than an outer diameter of the distal end surface of the second seat part 76 and larger than an inner diameter of the distal end surface of the second seat part 76.

The support disc 62 has an outer diameter larger than the outer diameter of the disc 59 and larger than the inner diameter of the outer annular portion 271. A rigidity of the support disc 62 is higher than a rigidity of the third damping valve 61. In the axial direction of the case member 56, an end surface of the support disc 62 on the bottom portion 71 side is positioned on the bottom portion 71 side with respect to the distal end surface of the second seat part 76.

The disc 63 has an outer diameter smaller than the outer diameter of the support disc 62 and larger than the outer diameter of the disc 59.

The disc 64 has an outer diameter smaller than an outer diameter of the outer annular portion 271 and larger than the outer diameter of the support disc 62. The annular member 65 has an outer diameter larger than the outer diameter of the support disc 62 and smaller than the outer diameter of the disc 64. The annular member 65 has a rigidity higher than the rigidity of the third damping valve 61.

The outer annular portion 271 of the third damping valve 61 is configured such that an outer circumferential side separable portion 275 on an outer circumferential side is separably in contact with the second seat part 76 of the case member 56. The outer circumferential side separable portion 275 has an annular shape as illustrated by the two-dot chain line in FIG. 3. The outer annular portion 271 closes a gap between itself and the second seat part 76 as illustrated in FIG. 2 when the outer circumferential side separable portion 275 is seated on the second seat part 76 over the entire circumference. The outer annular portion 271 opens the gap between itself and the second seat part 76 when the outer circumferential side separable portion 275 is separated from the second seat part 76.

Also, the outer annular portion 271 is configured such that an inner circumferential side separable portion 276 on an inner circumferential side is separably in contact with the support disc 62. The support disc 62 is a seat part on which the outer annular portion 271 is seated. The inner circumferential side separable portion 276 has an annular shape as illustrated by the two-dot chain line in FIG. 3. The inner circumferential side separable portion 276 has a smaller diameter than the outer circumferential side separable portion 275. As illustrated in FIG. 2, in the outer annular portion 271, the outer circumferential side separable portion 275 on one side in a thickness direction and on the outer circumferential side comes into contact with the second seat part 76, while the inner circumferential side separable portion 276 on the opposite side in the thickness direction and on the inner circumference side comes into contact with the support disc 62. In the axial direction of the case member 56, the end surface of the support disc 62 on the bottom portion 71 side is positioned on the bottom portion 71 side with respect to the distal end surface of the second seat part 76. Therefore, the outer annular portion 271 that comes into contact with the second seat part 76 and the support disc 62 is elastically deformed in a tapered shape such that the inner circumferential side is positioned on the bottom portion 71 side with respect to the outer circumferential side. The outer annular portion 271 closes the gap between itself and the support disc 62 when the inner circumferential side separable portion 276 is seated on the support disc 62 over the entire circumference, and opens the gap between itself the support disc 62 when the inner circumferential side separable portion 276 is separated from the support disc 62. In a state in which the outer annular portion 271 is seated on the support disc 62 over the entire circumference, the support disc 62 closes the gap between the outer annular portion 271 and the inner annular portion 272 of the third damping valve 61.

As illustrated in FIG. 3, the outer circumferential side separable portion 275 and the inner circumferential side separable portion 276 are both at positions separated outward in the radial direction from the two support portions 273. A range between the outer circumferential side separable portion 275 and the inner circumferential side separable portion 276 in the outer annular portion 271 is a pressure receiving portion 278 which is a range of a pressure receiving area that receives a pressure during both the expansion and compression strokes. The pressure receiving portion 278 has a sufficiently higher rigidity than the two support portions 273, and when the valve opens, the pressure receiving portion 278 operates similarly to a simply supported valve without the two support portions 273 and deforms similarly to a simply supported valve.

As illustrated in FIG. 2, in the third damping valve 61, the outer circumferential side separable portion 275 on the outer circumferential side of the outer annular portion 271 is separably disposed on the annular second seat part 76 of the case member 56. Also, the support disc 62 is provided on a side of the third damping valve 61 opposite to the second seat part 76 in a thickness direction, and supports the inner circumferential side separable portion 276 on a radially inner side of the outer circumferential side separable portion 275 in the outer annular portion 271. The outer annular portion 271 is separably disposed on the annular support disc 62 at the inner circumferential side separable portion 276 on the inner circumferential side. The third damping valve 61 forms a valve chamber 280 between itself and the case member 56. The second damping valve 58 is disposed in the valve chamber 280. The valve chamber 280 is in constant communication with the second passage 192 via the throttle 96 of the case member 56.

In the second damping force generation mechanism 211 on the extension side described above, a fixed orifice that allows communication between the bypass passage 205 and the valve chamber 280 is not formed in either the first seat part 75 and the second damping valve 58 that comes into contact with the first seat part 75 even when they are in a contact state. That is, a fixed orifice that is in constant communication with the valve chamber 280 is not formed in the bypass passage 205. The bypass passage 205 is not a passage that allows constant communication between the back pressure chamber 171 and the valve chamber 280.

When the outer annular portion 271 of the third damping valve 61 is seated on the second seat part 76 at the outer circumferential side separable portion 275 on the outer circumferential side, the second seat part 76 blocks a passage between the outer annular portion 271 of the third damping valve 61 and the second seat parts 76.

The outer circumferential side of the outer annular portion 271 of the third damping valve 61 including the outer circumferential side separable portion 275 constitutes a sub-valve 281 that can be separated from and seated on the second seat part 76. The sub-valve 281 allows the first passage 43, the second passage 192, the throttle 96, and the valve chamber 280 to communicate with the lower chamber 20 by being separated from the second seat part 76. At this time, the sub-valve 281 generates a damping force by suppressing a flow of the oil fluid between itself and the second seat part 76. The sub-valve 281 serves as a discharge valve that opens when the oil fluid is discharged from the upper chamber 19 to the lower chamber 20 through a gap between itself and the second seat part 76. The sub-valve 281 serves as a valve that restricts an inflow of the oil fluid from the lower chamber 20 to the upper chamber 19 through the gap between itself and the second seat part 76.

The passage between the sub-valve 281 and the second seat part 76 that appears when the valve opens constitutes an outflow passage 285. The outflow passage 285 is a passage on the extension side through which the oil fluid flows out from the upper chamber 19 on an upstream side toward the lower chamber 20 on a downstream side when the piston 18 moves to the upper chamber 19 side, that is, during the extension stroke.

The sub-valve 281 and the second seat part 76 are provided in the outflow passage 285 on the extension side, and constitute a third damping force generation mechanism 286 on the extension side that generates a damping force by opening and closing the outflow passage 285 to suppress a flow of the oil fluid from the outflow passage 285 to the lower chamber 20. The sub-valve 281 serves as a sub-valve on the extension side.

In the third damping force generation mechanism 286 on the extension side, a fixed orifice that allows communication between the upper chamber 19 and the lower chamber 20 is not formed in either the second seat part 76 or the sub-valve 281 that comes into contact with the second seat part 76 even when they are in a contact state. That is, the third damping force generation mechanism 286 on the extension side does not allow communication between the upper chamber 19 and the lower chamber 20 in a state in which the second seat part 76 and the sub-valve 281 are in contact with each other over the entire circumference. In other words, the outflow passage 285 does not include a fixed orifice formed to allow constant communication between the upper chamber 19 and the lower chamber 20. The outflow passage 285 is not a passage that allows constant communication between the upper chamber 19 and the lower chamber 20.

Here, a moving speed of the piston 18 in the axial direction is referred to as a piston speed. In the extension stroke, in a region in which the piston speed is lower than a predetermined value, the sub-valve 281 of the third damping valve 61 opens with the first damping valve 52 closed. The disc 64 and the annular member 65 suppress deformation of the third damping valve 61 in an opening direction beyond a specified limit during the extension stroke.

When the outer annular portion 271 of the third damping valve 61 is seated on the support disc 62 at the inner circumferential side separable portion 276 on the inner circumferential side, the support disc 62 blocks a passage between the outer annular portion 271 and the inner annular portion 272 of the third damping valve 61.

The inner circumferential side of the outer annular portion 271 of the third damping valve 61 including the inner circumferential side separable portion 276 constitutes a sub-valve 291 that can be separated from and seated on the support disc 62. The sub-valve 291 allows the lower chamber 20 to communicate with the upper chamber 19 via a gap between itself and the support disc 62, a passage between the outer annular portion 271 and the inner annular portion 272, the valve chamber 280, the throttle 96, and the second passage 192, and the first passage 43 by being separated from the support disc 62. At this time, the sub-valve 291 generates a damping force by suppressing a flow of the oil fluid between itself and the support disc 62. The sub-valve 291 is an inflow valve that opens when the oil fluid is caused to flow in from the lower chamber 20 via the gap between itself and the support disc 62. The sub-valve 291 is a valve that restricts an outflow of the oil fluid from the upper chamber 19 to the lower chamber 20 via the gap between itself and the support disc 62.

The passage between the sub-valve 291 and the support disc 62 that appears when the valve opens constitutes an inflow passage 295. The inflow passage 295 is a compression-side passage through which the oil fluid flows out from the lower chamber 20 on the upstream side toward the upper chamber 19 on the downstream side when the piston 18 moves to the lower chamber 20 side, that is, during the compression stroke.

The sub-valve 291 and the support disc 62 are provided in the inflow passage 295 on the compression side, and constitute a third damping force generation mechanism 296 on the compression side that generates a damping force by opening and closing the inflow passage 295 to suppress a flow of the oil fluid from the inflow passage 295 to the upper chamber 19. The sub-valve 291 is a sub-valve on the compression side. Here, a valve opening pressure of the third damping force generation mechanism 296 is set lower than a valve opening pressure of the check valve 175.

In the third damping force generation mechanism 296 on the compression side, a fixed orifice that allows communication between the lower chamber 20 and the upper chamber 19 is not formed in either the support disc 62 or the sub-valve 291 that comes into contact with the support disc 62 even when they are in a contact state. That is, the third damping force generation mechanism 296 on the compression side does not allow communication between the upper chamber 19 and the lower chamber 20 in a state in which the support disc 62 and the sub-valve 291 are in contact with each other over the entire circumference. In other words, the inflow passage 295 does not include a fixed orifice provided to allow constant communication between the lower chamber 20 and the upper chamber 19. The inflow passage 295 is not a passage that allows constant communication between the lower chamber 20 and the upper chamber 19.

The first damping force generation mechanism 42 on the compression side includes one disc 221, a plurality of discs 222, one disc 223, one disc 224, one disc 225, one disc 226, and one annular member 227 on the valve seat part 49 side in the axial direction of the piston 18 in order from the piston 18 side in the axial direction of the piston 18. The discs 221 to 226 and the annular member 227 are made of a metal and have a bored circular flat plate shape each having a constant thickness. The mounting shaft part 28 of the piston rod 21 is fitted to an inner side of all the discs 221 to 226 and the annular member 227.

The disc 221 has an outer diameter smaller than an inner diameter of the valve seat part 49 of the piston 18. The plurality of discs 222 have the same outer diameter, which is slightly larger than an outer diameter of the valve seat part 49 of the piston 18. The disc 223 has an outer diameter smaller than an outer diameter of the disc 224. The disc 224 has an outer diameter smaller than the outer diameter of the disc 223. The disc 225 has an outer diameter smaller than the outer diameter of the disc 224. The disc 226 has an outer diameter the same as the outer diameter of the disc 224. The annular member 227 has an outer diameter smaller than the outer diameter of the disc 226 and larger than the outer diameter of the disc 225. The annular member 227 has a larger thickness and a higher rigidity than the discs 221 to 226. The annular member 227 is in contact with the shaft step part 29 of the piston rod 21.

The discs 222 to 224 constitute a first damping valve 235 that can be separated from and seated on the valve seat part 49. The first damping valve 235, together with the valve seat part 49 of the piston 18, constitutes the first damping force generation mechanism 42. The first damping valve 235 separates from the valve seat part 49 and opens. Then, the first damping valve 235 causes the oil fluid from the first passage 44 to flow into the upper chamber 19 via a space between itself and the valve seat part 49. The first passage 44 serves as a passage on the compression side through which the oil fluid in the lower chamber 20 flows due to movement of the piston 18 to the lower chamber 20 side. The first passage 44 is configured such that the oil fluid as a working fluid flows from the lower chamber 20 on one side toward the upper chamber 19 on the other side during the compression stroke. The first damping force generation mechanism 42 on the compression side formed of the valve seat part 49 and the first damping valve 235 is provided in the first passage 44. The first damping force generation mechanism 42 generates a damping force by opening and closing the first passage 44 with the first damping valve 235 to suppress a flow of the oil fluid. The first damping force generation mechanism 42 is provided in the first passage 44 and changes a flow path area due to a flow of the oil fluid serving as a working fluid.

In the first damping force generation mechanism 42 on the compression side, a fixed orifice that allows communication between the lower chamber 20 and the upper chamber 19 is not formed in either the valve seat part 49 or the first damping valve 235 that comes into contact with the valve seat part 49 even when they are in a contact state. That is, the first damping force generation mechanism 42 on the compression side does not allow communication between the lower chamber 20 and the upper chamber 19 in a state in which the valve seat part 49 and the first damping valve 235 are in contact with each other over the entire circumference. In other words, the first passage 44 does not include a fixed orifice formed to allow constant communication between the lower chamber 20 and the upper chamber 19. The first passage 44 is not a passage that allows constant communication between the lower chamber 20 and the upper chamber 19. The disc 226 and the annular member 227 suppress deformation of the first damping valve 235 in an opening direction beyond a specified limit.

Here, in the compression stroke, in a region in which the piston speed is lower than a predetermined value, the sub-valve 291 of the third damping valve 61 opens with the first damping valve 235 closed.

The case member 56, the first damping valve 52, the discs 53 and 54, and the partition member 111 constitute a frequency sensitive mechanism 311 that makes a damping force variable in response to a frequency of reciprocation of the piston 18 (hereinafter referred to as a piston frequency). In the frequency sensitive mechanism 311, the lip 113 of the partition member 111 deforms in accordance with the frequency of reciprocation of the piston 18, thereby changing a capacity of the back pressure chamber 171 that is in constant communication with the upper chamber 19 and a capacity of the variable chamber 172 that is in constant communication with the lower chamber 20. That is, in the extension stroke, a differential pressure between the back pressure chamber 171 and the lower chamber 20 is higher on the back pressure chamber 171 side than on the lower chamber 20 side. Then, a pressure of the back pressure chamber 171 is received by the first pressure receiving portion 132, and the lip 113 deforms to the bottom portion 71 side and the outer cylindrical portion 73 side while maintaining a seal state with the outer cylindrical portion 73. Thereby, a volume of the back pressure chamber 171 increases. In the compression stroke, contrary to the extension stroke, the lower chamber 20 side has a higher pressure than the back pressure chamber 171 side. If the differential pressure between the lower chamber 20 side and the back pressure chamber 171 side is lower than a predetermined value, a pressure on the lower chamber 20 side is received by the second pressure receiving portion 133, and the lip 113 deforms to a side opposite to the bottom portion 71 and to the inner cylindrical portion 72 side while maintaining the sealed state with the outer cylindrical portion 73. Thereby, a volume of the variable chamber 172 increases. Also, during the compression stroke, if a pressure on the lower chamber 20 side is higher than that on the back pressure chamber 171 side by a predetermined value or more, the seal portion 131 of the lip 113 separates from the outer cylindrical portion 73 to open the check valve 175, and the oil fluid is allowed to flow from the lower chamber 20 into the back pressure chamber 171.

The piston rod 21 is configured such that the annular member 227, the disc 226, the disc 225, the disc 224, the disc 223, the plurality of discs 222, the disc 221, the piston 18, the disc 50, the first damping valve 52, the disc 53, the disc 54, the case member 56, the plurality of discs 57, the plurality of discs 59, the third damping valve 61, the support disc 62, the disc 63, the disc 64, and the annular member 65 are stacked in that order on the shaft step part 29 with the mounting shaft part 28 inserted through the inside of them. At this time, the case member 56 fits the seal member 156 of the first damping valve 52 into the outer cylindrical portion 73. Further, the partition member 111 is attached to the case member 56 in advance by press-fitting before the assembly described above to the piston rod 21.

With the parts from the annular member 227 to the annular member 65 disposed on the piston rod 21 as described above, a nut 315 is screwed onto the male screw 31 of the mounting shaft part 28 that protrudes from the annular member 65. Thereby, the parts from the annular member 227 to the annular member 65 stacked as described above are clamped in the axial direction by being sandwiched by the shaft step part 29 of the piston rod 21 and the nut 315 at the inner circumferential side of them or in their entirety. In this state, the third damping valve 61 is configured such that the inner annular portion 272 is clamped in the axial direction, and the outer annular portion 271 comes into contact with the second seat part 76 and the support disc 62. In this state, the outer annular portion 271 is elastically deformed into a tapered shape. In the outer annular portion 271, the inner circumferential side separable portion 276 is positioned on the bottom portion 71 side with respect to the outer circumferential side separable portion 275 in the axial direction.

Of the first damping force generation mechanism 41 and the third damping force generation mechanism 286 which are both on the extension side, the first damping valve 52 of the first damping force generation mechanism 41 has a higher valve opening pressure than the sub-valve 281 of the third damping force generation mechanism 286. Therefore, in the extension stroke, in a region in which a piston speed is lower than a predetermined value, the third damping force generation mechanism 286 opens while the first damping force generation mechanism 41 is closed. In other words, the third damping force generation mechanism 286 opens and generates a damping force when the piston speed is lower than a piston speed at which the first damping force generation mechanism 41 opens. In a region in which the piston speed is equal to or higher than the predetermined value, both the first damping force generation mechanism 41 and the third damping force generation mechanism 286 open.

Of the first damping force generation mechanism 42 and the third damping force generation mechanism 296 which are both on the compression side, the first damping valve 235 of the first damping force generation mechanism 42 has a higher valve opening pressure than the sub-valve 291 of the third damping force generation mechanism 296. Therefore, in the compression stroke, in a region in which the piston speed is lower than the predetermined value, the third damping force generation mechanism 286 opens while the first damping force generation mechanism 42 is closed. In other words, the third damping force generation mechanism 296 opens and generates a damping force when the piston speed is lower than a piston speed at which the first damping force generation mechanism 42 opens. In a region in which the piston speed is equal to or higher than the predetermined value, both the first damping force generation mechanism 42 and the third damping force generation mechanism 296 open.

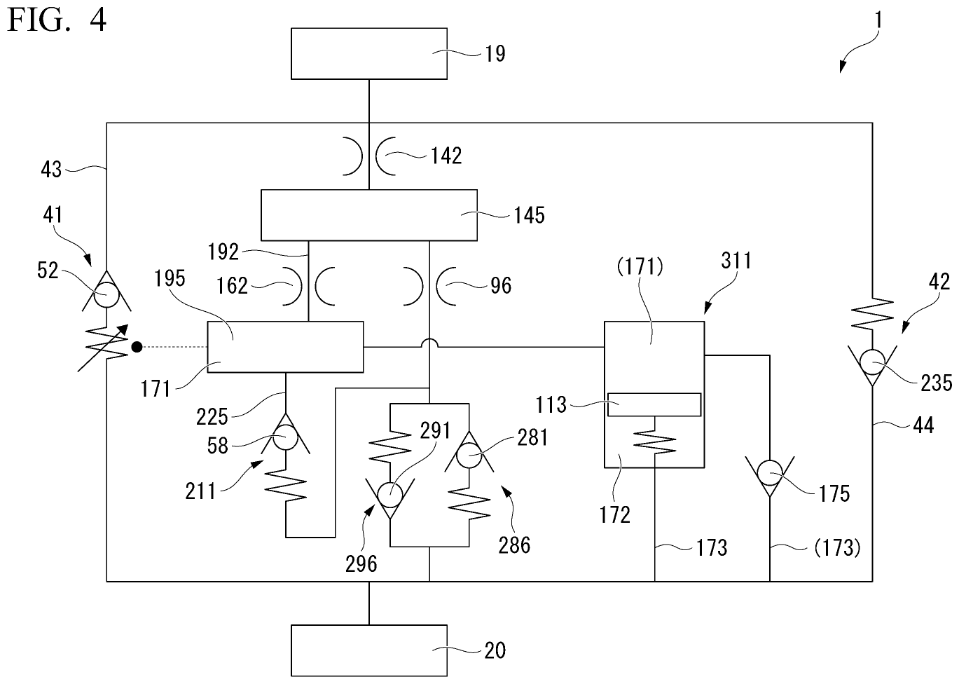

A hydraulic circuit diagram of a portion in the vicinity of the piston 18 of the shock absorber 1 configured as described above is shown in FIG. 4. As shown in FIG. 4, the first passage 43 connecting the upper chamber 19 and the lower chamber 20 is provided in the shock absorber 1. The first damping force generation mechanism 41 including the first damping valve 52 is provided in the first passage 43. Also, the upper chamber 19 communicates with the rod chamber 145 via the throttle 142. The rod chamber 145 communicates with the back pressure chamber 171 of the passage chamber 195 via the throttle 162. The throttle 142, the rod chamber 145, and the throttle 162 constitute the second passage 192. The pressure in the back pressure chamber 171 acts on the first damping valve 52. The back pressure chamber 171 of the passage chamber 195 constitutes the frequency sensitive mechanism 311. The frequency sensitive mechanism 311 partitions the back pressure chamber 171 and the variable chamber 172 with the lip 113. The variable chamber 172 communicates with the lower chamber 20 via the passage portion 173. The bypass passage 205 communicates with the back pressure chamber 171. The second damping force generation mechanism 211 including the second damping valve 58 is provided in the bypass passage 205. The third damping force generation mechanism 286 on the extension side including the sub-valve 281 and the third damping force generation mechanism 296 on the compression side including the sub-valve 291 are provided between the second damping force generation mechanism 211 and the lower chamber 20. The third damping force generation mechanisms 286 and 296 communicate with the rod chamber 145 via the throttle 96. The check valve 175 is provided between the lower chamber 20 and the back pressure chamber 171. The first passage 44 is provided by connecting the lower chamber 20 and the upper chamber 19. The first damping force generation mechanism 42 including the first damping valve 235 is provided in the first passage 44. A fixed orifice that allows constant communication between the upper chamber 19 and the lower chamber 20 is not provided in the hydraulic circuit diagram of the portion in the vicinity of the piston 18.

As illustrated in FIG. 1, the base valve 25 described above is provided between the inner cylinder 3 and the bottom member 12 of the outer cylinder 4. The base valve 25 includes a base valve member 321, a disc valve 322, a disc valve 323, and an attachment pin 324. The base valve 25 is placed on the bottom member 12 at the base valve member 321, and is fitted to the inner cylinder 3 at the base valve member 321. The base valve member 321 partitions the lower chamber 20 and the reservoir chamber 6. The disc valve 322 is provided on a lower side of the base valve member 321, that is, on the reservoir chamber 6 side. The disc valve 323 is provided on an upper side of the base valve member 321, that is, on the lower chamber 20 side. The attachment pin 324 attaches the disc valve 322 and the disc valve 323 to the base valve member 321.

The base valve member 321 has an annular shape, and the attachment pin 324 is inserted through a center thereof in the radial direction. A plurality of passage holes 325 and a plurality of passage holes 326 are formed in the base valve member 321. The plurality of passage holes 325 allow the oil fluid to flow between the lower chamber 20 and the reservoir chamber 6. The plurality of passage holes 326 are disposed on an outer side of the plurality of passage holes 325 in a radial direction of the base valve member 321. The plurality of passage holes 326 allow the oil fluid to flow between the lower chamber 20 and the reservoir chamber 6. The disc valve 322 on the reservoir chamber 6 side allows the oil fluid to flow from the lower chamber 20 to the reservoir chamber 6 through the passage holes 325. On the other hand, the disc valve 322 suppresses a flow of the oil fluid from the reservoir chamber 6 to the lower chamber 20 through the passage holes 325. The disc valve 323 allows the oil fluid to flow from the reservoir chamber 6 to the lower chamber 20 through the passage holes 326. On the other hand, the disc valve 323 suppresses a flow of the oil fluid from the lower chamber 20 to the reservoir chamber 6 through the passage holes 326.

The disc valve 322 and the base valve member 321 constitute a damping valve mechanism 327. The damping valve mechanism 327 opens during the compression stroke of the shock absorber 1 to allow the oil fluid to flow from the lower chamber 20 to the reservoir chamber 6 and generate a damping force. The disc valve 323 and the base valve member 321 constitute a suction valve mechanism 328. The suction valve mechanism 328 opens during the extension stroke of the shock absorber 1 to allow the oil fluid to flow from the reservoir chamber 6 to the lower chamber 20. Further, the suction valve mechanism 328 performs a function of causing the liquid to flow from the reservoir chamber 6 to the lower chamber 20 substantially without generating a damping force so that a shortage of the liquid caused mainly due to extension of the piston rod 21 from the cylinder 2 is supplemented.

Next, an operation of the shock absorber 1 will be described.

“Low frequency very low speed region x1 in which piston frequency is low, and piston speed is lower than first predetermined value v1 in extension stroke”

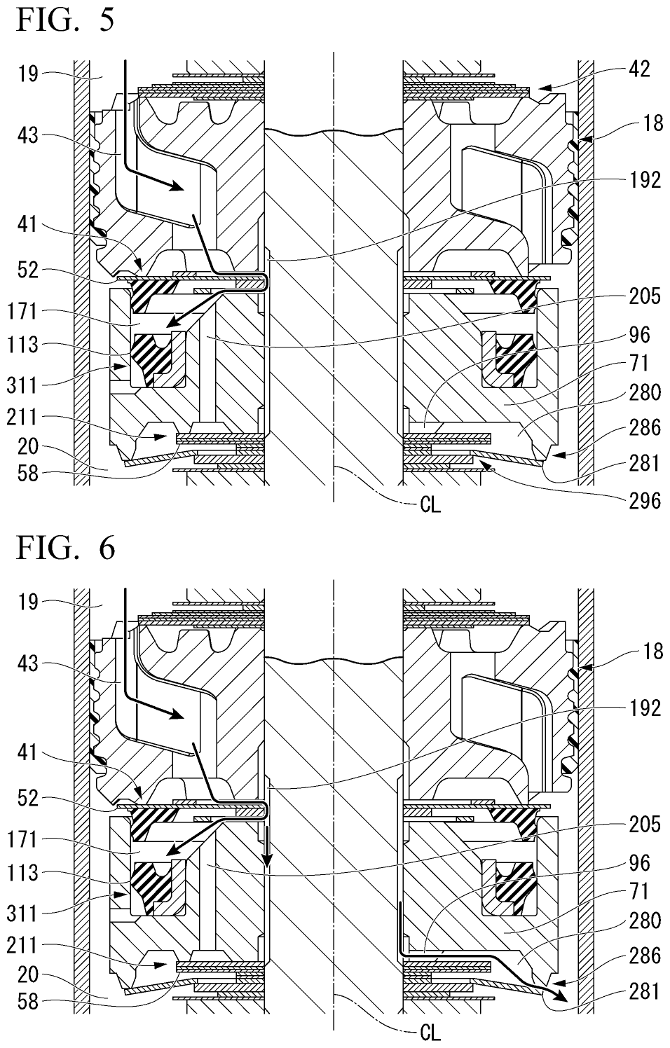

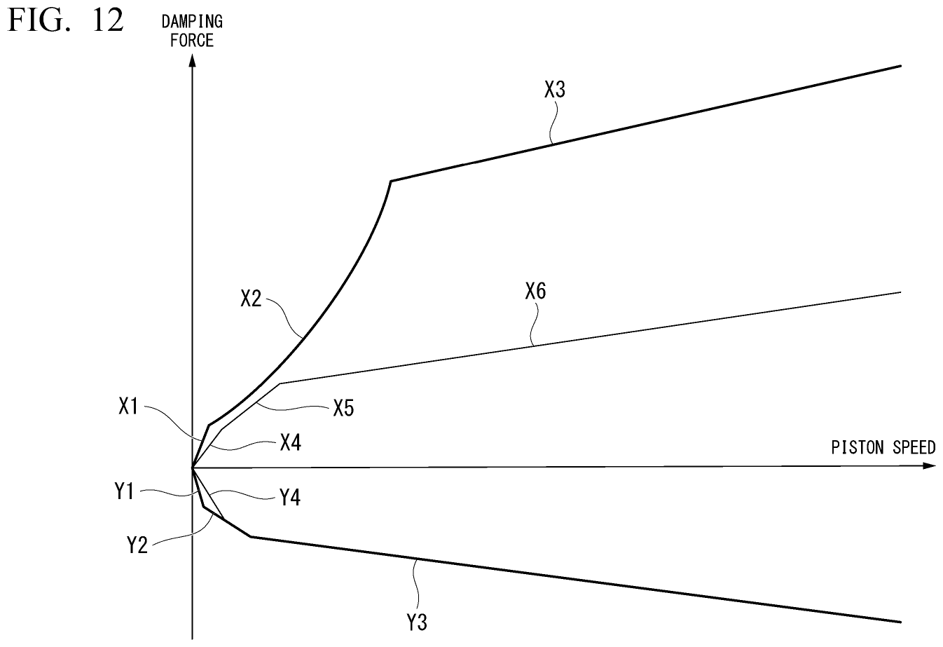

In the low frequency very low speed region x1, the first damping force generation mechanism 41, the second damping force generation mechanism 211, and the third damping force generation mechanism 286 illustrated in FIG. 5 do not open. Then, the oil fluid from the upper chamber 19 flows into the back pressure chamber 171 through the first passage 43 and the second passage 192 as indicated by the thick-line arrow in FIG. 5. Then, the lip 113 of the frequency sensitive mechanism 311 deforms to the bottom portion 71 side. In the low frequency very low speed region x1, since the piston frequency is low and the piston 18 makes a large stroke, a large amount of the oil fluid is introduced from the upper chamber 19 into the back pressure chamber 171 at the beginning of the stroke. Therefore, the lip 113 of the frequency sensitive mechanism 311 deforms to the bottom portion 71 side to near the limit, and thereafter does not readily deform (high spring region). Also, none of the first damping force generation mechanisms 41 and 42, the second damping force generation mechanisms 211, and the third damping force generation mechanisms 286 and 296 has a fixed orifice that allows constant communication between the upper chamber 19 and the lower chamber 20. As a result, in the low frequency very low speed region x1, an increasing rate of the damping force with respect to an increase in the piston speed is high as indicated by the thick line X1 in FIG. 12.

“Low frequency minute low speed region x2 in which piston frequency is low, and piston speed is equal to or higher than first predetermined value v1 and lower than second predetermined value v2 in extension stroke”

In the low frequency minute low speed region x2, as indicated by the thick-line arrow in FIG. 6, the oil fluid from the upper chamber 19 largely deforms the lip 113 of the frequency sensitive mechanism 311 to the bottom portion 71 side similarly to that in the low frequency very low speed region x1. Thereafter, the oil fluid from the upper chamber 19 is not readily introduced into the back pressure chamber 171, flows from the second passage 192 to the valve chamber 280 through the throttle 96, and opens the sub-valve 281 of the third damping force generation mechanism 286 to flow into the lower chamber 20. As a result, in the low frequency minute low speed region x2, the increasing rate of the damping force with respect to an increase in the piston speed is lower than that in the low frequency very low speed region x1 as indicated by the thick line X2 in FIG. 12. In the low frequency minute low speed region x2, since the lip 113 of the frequency sensitive mechanism 311 is deformed to near the limit, the pressure in the back pressure chamber 171 becomes high. Opening of the first damping valve 52 of the first damping force generation mechanism 41 is limited by the pressure in the back pressure chamber 171.

Damping force characteristics in the low frequency very low speed region x1 described above are adjusted according to specifications of the sub-valve 281 of the third damping force generation mechanism 286.

Damping force characteristics in the low frequency minute low speed region x2 are adjusted by specifications of the sub-valve 281 and the throttle 96. The throttle 96 corresponds to an area of the orifice allowing direct communication between the upper chamber 19 and the lower chamber 20, and the damping force characteristics in the low frequency minute low speed region x2 are adjusted by the area.

“Low frequency low-medium-high-speed region x3 in which piston frequency is low, and piston speed is equal to higher than second predetermined value v2 in extension stroke”

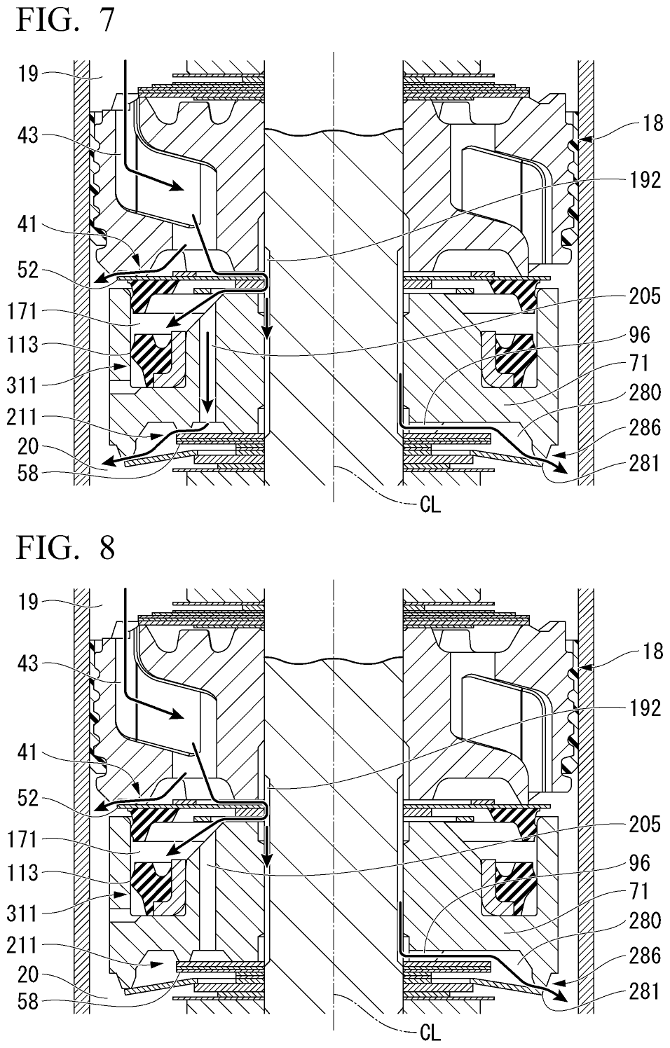

In the low frequency low-medium-high-speed region x3, as indicated by the thick-line arrow in FIG. 7, the oil fluid from the upper chamber 19 largely deforms the lip 113 of the frequency sensitive mechanism 311 to the bottom portion 71 side similarly to that in the low frequency minute low speed region x2. Thereafter, the oil fluid from the upper chamber 19 flows from the second passage 192 to the valve chamber 280 through the throttle 96, and opens the sub-valve 281 to flow into the lower chamber 20. In addition, in the low frequency low-medium-high-speed region x3, the oil fluid from the upper chamber 19 flows from the first passage 43 into the lower chamber 20 by opening the first damping valve 52 of the first damping force generation mechanism 41. In the low frequency low-medium-high-speed region x3, the pressure in the back pressure chamber 171 is higher than that in the low frequency minute low speed region x2. Therefore, in the low frequency low-medium-high-speed region x3, the oil fluid introduced into the back pressure chamber 171 from the upper chamber 19 through the first passage 43 and the second passage 192 flows into the bypass passage 205, opens the second damping valve 58 of the second damping force generation mechanism 211, flows into the valve chamber 280, further opens the sub-valve 281, and flows into the lower chamber 20. As a result, in the low frequency low-medium-high-speed region x3, the increasing rate of the damping force with respect to an increase in the piston speed is lower than that in the low frequency minute low speed region x2 as indicated by the thick line X3 in FIG. 12.

Damping force characteristics in the low frequency low-medium-high-speed region x3 are adjusted by specifications of the first damping valve 52 and the second damping valve 58 in addition to the specifications of the sub-valve 281 and the throttle 96.

“High frequency very low speed region x4 in which piston frequency is higher than low frequency described above, and piston speed is lower than third predetermined value v3 in extension stroke”

In the high frequency very low speed region x4, the first damping force generation mechanism 41, the second damping force generation mechanism 211, and the third damping force generation mechanism 286 illustrated in FIG. 5 do not open. Then, as indicated by the thick-line arrow in FIG. 5, the oil fluid from the upper chamber 19 flows into the back pressure chamber 171 through the first passage 43 and the second passage 192 similarly to that in the low frequency very low speed region x1. Then, the lip 113 of the frequency sensitive mechanism 311 deforms to the bottom portion 71 side. In the high frequency very low speed region x4, the piston frequency is high and the stroke of the piston 18 is small. Therefore, an amount of the oil fluid introduced from the upper chamber 19 into the back pressure chamber 171 is smaller than that in the low frequency very low speed region x1. Therefore, the lip 113 of the frequency sensitive mechanism 311 is not deformed to near the limit, and is easily deformed (low spring region). As a result, the oil fluid introduced from the upper chamber 19 into the back pressure chamber 171 can be absorbed by the deformation of the lip 113. Therefore, in the high frequency very low speed region x4, although the increasing rate of the damping force with respect to an increase in the piston speed is high, the damping force at the same piston speed is lower than that in the low frequency very low speed region x1 as indicated by the thin line X4 in FIG. 12, thereby exhibiting soft characteristics.

“High frequency minute low speed region x5 in which piston frequency is higher than low frequency described above, and piston speed is equal to or higher than third predetermined value v3 and lower than fourth predetermined value v4 in extension stroke”

In the high frequency minute low speed region x5, as indicated by the thick-line arrow in FIG. 6, the oil fluid from the upper chamber 19 deforms the lip 113 of the frequency sensitive mechanism 311 to the bottom portion 71 side similarly to that in the high frequency very low speed region x4. In addition, in the high frequency minute low speed region x5, the oil fluid from the upper chamber 19 flows into the valve chamber 280 via the first passage 43, the second passage 192, and the throttle 96, opens the sub-valve 281 of the third damping force generation mechanism 286, and flows into the lower chamber 20. As a result, in the high frequency minute low speed region x5, the increasing rate of the damping force with respect to an increase in the piston speed is lower than that in the high frequency very low speed region x4 as indicated by the thin line X5 in FIG. 12. Also, in the high frequency minute low speed region x5, the lip 113 deforms to the bottom portion 71 side to introduce the oil fluid from the upper chamber 19 into the back pressure chamber 171. Therefore, in the high frequency minute low speed region x5, the damping force at the same piston speed is lower than that in the low frequency minute low speed region x2, thereby exhibiting soft characteristics.

Damping force characteristics in the high frequency minute low speed region x5 are adjusted by specifications of the sub-valve 281 and the throttle 96.

“High frequency low-medium-high-speed region x6 in which piston frequency is higher than low frequency described above, and piston speed is equal to or higher than fourth predetermined value v4 in extension stroke in extension stroke”

In the high frequency low-medium-high-speed region x6, as indicated by the thick-line arrow in FIG. 8, the oil fluid from the upper chamber 19 deforms the lip 113 of the frequency sensitive mechanism 311 to the bottom portion 71 side similarly to that in the high frequency minute low speed region x5. At the same time, the oil fluid from the upper chamber 19 flows into the valve chamber 280 via the first passage 43, the second passage 192, and the throttle 96, opens the sub-valve 281, and flows into the lower chamber 20. In the high frequency low-medium-high-speed region x6, since an amount of the oil fluid introduced into the back pressure chamber 171 is small, an increase in pressure of the back pressure chamber 171 is suppressed by the deformation of the lip 113. Therefore, the first damping valve 52 of the first damping force generation mechanism 41 is easily opened. Therefore, in addition to the above, the oil fluid from the upper chamber 19 passes through the first passage 43, opens the first damping valve 52 of the first damping force generation mechanism 41, and flows into the lower chamber 20. As a result, in the high frequency low-medium-high-speed region x6, the increasing rate of the damping force with respect to an increase in the piston speed is lower than that in the high frequency minute low speed region x5 as indicated by the thin line X6 in FIG. 12. Also, in the high frequency low-medium-high-speed region x6, the damping force at the same piston speed is lower than that in the low frequency low-medium-high-speed region x3, thereby exhibiting soft characteristics. In the high frequency low-medium-high-speed region x6, since the increase in pressure of the back pressure chamber 171 is suppressed, the second damping force generation mechanism 211 remains in a closed state.

Damping force characteristics in the high frequency low-medium-high-speed region x6 are adjusted by specifications of the first damping valve 52 in addition to the specifications of the sub-valve 281 and the throttle 96.

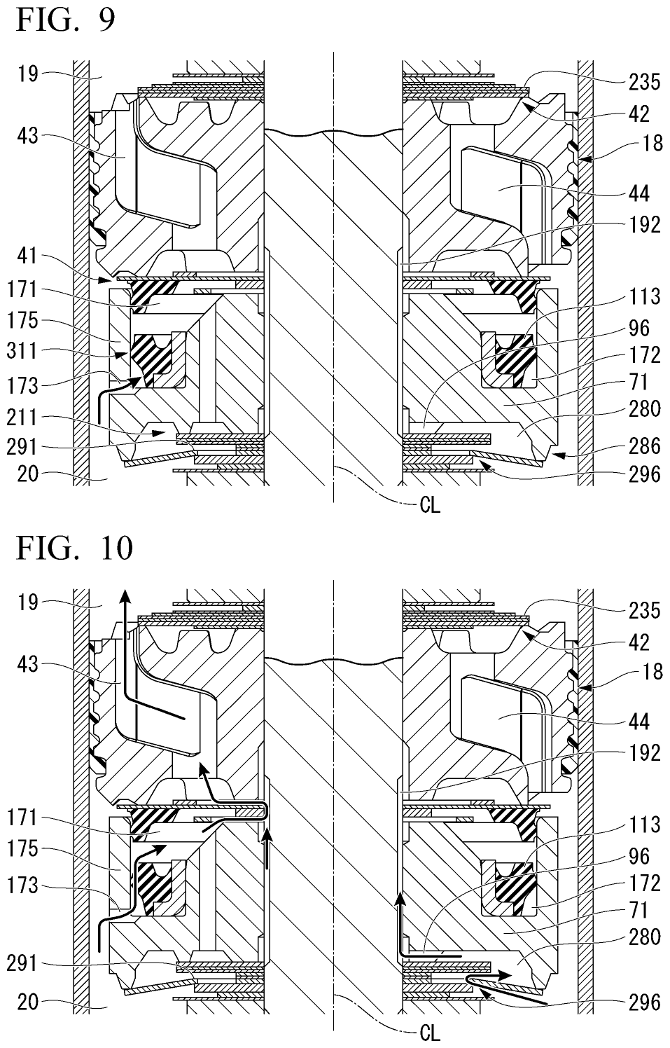

“Low frequency very low speed region y1 in which piston frequency is low, and piston speed is lower than fifth predetermined value v5 in compression stroke” In the low frequency very low speed region y1, the first damping force generation mechanism 42 and the third damping force generation mechanism 296 illustrated in FIG. 9 do not open. Then, the oil fluid from the lower chamber 20 is introduced into the variable chamber 172 via the passage portion 173 as indicated by the thick-line arrow in FIG. 9. Then, the lip 113 of the frequency sensitive mechanism 311 deforms to a side opposite to the bottom portion 71. In the low frequency very low speed region y1, since the piston frequency is low and the piston 18 makes a large stroke, a large amount of the oil fluid is introduced from the lower chamber 20 into the variable chamber 172 at the beginning of the stroke. Therefore, the lip 113 of the frequency sensitive mechanism 311 deforms to a side opposite to the bottom portion 71 to near the limit, and does not readily deform (high spring region). Also, none of the first damping force generation mechanisms 41 and 42 and the third damping force generation mechanisms 286 and 296 has a fixed orifice that allows constant communication between the lower chamber 20 and the upper chamber 19. As a result, in the low frequency very low speed region y1, the increasing rate of the damping force with respect to an increase in the piston speed is high as indicated by the thick line Y1 in FIG. 12, thereby exhibiting hard characteristics. Here, since a valve opening pressure of the check valve 175 including the lip 113 is set higher than a valve opening pressure of the sub-valve 291 of the third damping force generation mechanism 296, the check valve 175 is configured not to open until the sub-valve 291 opens as will be described later.

“Low frequency minute low speed region y2 in which piston frequency is low, and piston speed is equal to or higher than fifth predetermined value v5 and lower than sixth predetermined value v6 in compression stroke”

In the low frequency minute low speed region y2, the oil fluid from the lower chamber 20 opens the sub-valve 291 of the third damping force generation mechanism 296 and flows into the upper chamber 19 via the valve chamber 280, the throttle 96, the second passage 192, and the first passage 43 as indicated by the thick-line arrow in FIG. 10. At the same time, the oil fluid from the lower chamber 20 is introduced into the variable chamber 172 from the passage portion 173, opens the check valve 175, and flows into the upper chamber 19 via the back pressure chamber 171, the second passage 192, and the first passage 43. As a result, in the low frequency minute low speed region y2, the increasing rate of the damping force with respect to an increase in the piston speed is lower than that in the low frequency very low speed region y1 as indicated by the thick line Y2 in FIG. 12.

Damping force characteristics in the low frequency very low speed region y1 described above are adjusted by specifications of the sub-valve 291 of the third damping force generation mechanism 296.

Damping force characteristics in the low frequency minute low speed region y2 are adjusted by specifications of the check valve 175, the sub-valve 291, and the throttle 96.

“Low frequency low-medium-high-speed region y3 in which piston frequency is low, and piston speed is equal to or higher than sixth predetermined value v6 in compression stroke”

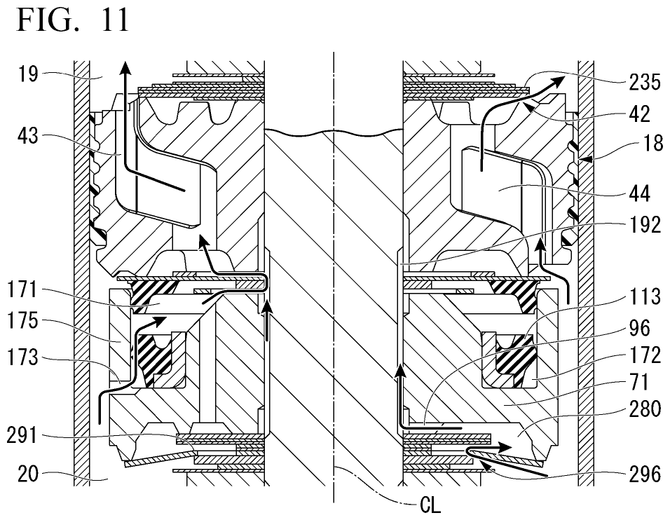

In the low frequency low-medium-high-speed region y3, as indicated by the thick-line arrow in FIG. 11, the oil fluid from the lower chamber 20 opens the sub-valve 291 and flows into the upper chamber 19 via the valve chamber 280, the throttle 96, the second passage 192, and the first passage 43 similarly to that in the low frequency minute low speed region y2. At the same time, the oil fluid from the lower chamber 20 flows from the passage portion 173 and the variable chamber 172 into the upper chamber 19 via the back pressure chamber 171, the second passage 192, and the first passage 43 by opening the check valve 175. In addition to these, in the low frequency low-medium-high-speed region y3, the oil fluid from the lower chamber 20 passes through the first passage 44, opens the first damping valve 235 of the first damping force generation mechanism 42, and flows into the upper chamber 19. As a result, in the low frequency low-medium-high-speed region y3, the increasing rate of the damping force with respect to an increase in the piston speed is lower than that in the low frequency minute low speed region y2 as indicated by the thick line Y3 in FIG. 12.

Damping force characteristics in the low frequency low-medium-high-speed region y3 are adjusted by specifications of the first damping valve 235 in addition to the specifications of the check valve 175, sub-valve 291, and throttle 96.

“High frequency very low speed region y4 in which piston frequency is higher than low frequency described above, and piston speed is lower than seventh predetermined value v7 in compression stroke”

In the high frequency very low speed region y4, the first damping force generation mechanism 42 and the third damping force generation mechanism 296 illustrated in FIG. 9 do not open. Then, the oil fluid from the lower chamber 20 is introduced into the variable chamber 172 via the passage portion 173 as indicated by the thick-line arrow in FIG. 9. Then, the lip 113 of the frequency sensitive mechanism 311 deforms to a side opposite to the bottom portion 71. In the high frequency very low speed region y4, since the piston frequency is high and the stroke of the piston 18 is small, an amount of the oil fluid introduced from the lower chamber 20 into the variable chamber 172 is smaller than that in the low frequency very low speed region y1.

Therefore, the lip 113 of the frequency sensitive mechanism 311 is not deformed to near the limit, and is easily deformed (low spring region). As a result, the oil fluid introduced from the lower chamber 20 into the variable chamber 172 can be absorbed by the deformation of the lip 113. Therefore, in the high frequency very low speed region y4, the damping force at the same piston speed has softer characteristics than those in the low frequency very low speed region y1 as indicated by the thin line Y4 in FIG. 12. A range of piston speed in the high frequency very low speed region y4 in the compression stroke is larger than that in the low frequency very low speed region y1 in the compression stroke.

“High frequency minute low speed region y5 in which piston frequency is higher than low frequency described above, and piston speed is equal to or higher than seventh predetermined value v7 and lower than eighth predetermined value v8 in compression stroke”

In the high frequency minute low speed region y5, as indicated by the thick-line arrow in FIG. 10, the oil fluid from the lower chamber 20 opens the sub-valve 291 and flows into the upper chamber 19 via the valve chamber 280, the throttle 96, the second passage 192, and the first passage 43 similarly to that in the low frequency minute low speed region y2. At the same time, the oil fluid from the lower chamber 20 flows from the passage portion 173 and the variable chamber 172 into the upper chamber 19 via the back pressure chamber 171, the second passage 192, and the first passage 43 by opening the check valve 175. In the high frequency minute low speed region y5, characteristics thereof are similar to the characteristics indicated by the thick line Y2 in FIG. 12, and the increasing rate of the damping force with respect to an increase in the piston speed is lower than that in the high frequency very low speed region y4.

“High frequency low-medium-high-speed region y6 in which piston frequency is higher than low frequency described above, and piston speed is equal to or higher than eighth predetermined value v8 in compression stroke”

In the high frequency low-medium-high-speed region y6, similarly to the low frequency low-medium-high-speed region y3, the oil fluid from the lower chamber 20 opens the sub-valve 291 and flows into the upper chamber 19 via the valve chamber 280, the throttle 96, the second passage 192, and the first passage 43 as indicated by the thick-line arrow in FIG. 11. At the same time, the oil fluid from the lower chamber 20 flows from the passage portion 173 and the variable chamber 172 into the upper chamber 19 via the back pressure chamber 171, the second passage 192, and the first passage 43 by opening the check valve 175. In addition to these, in the high frequency low-medium-high-speed region y6, the oil fluid from the lower chamber 20 passes through the first passage 44, opens the first damping valve 235 of the first damping force generation mechanism 42, and flows into the upper chamber 19. As a result, in the high frequency low-medium-high-speed region y6, characteristics thereof are similar to the characteristics indicated by the thick line Y3 in FIG. 12, and the increasing rate of the damping force with respect to an increase in the piston speed is lower than that in the high frequency minute low speed region y5.

A cutoff frequency that switches between hard and soft of the frequency sensitive mechanism 311 can be adjusted by changing a flow path area of the throttle 162 of the second passage 192.

During the compression stroke, the shock absorber 1 has characteristics in which the damping force characteristic due to the damping valve mechanism 327 is also combined.

The above-described Patent Document 1 describes a shock absorber in which a damping valve that opens when the piston moves includes a mechanism that causes a pressure from a chamber having a high pressure to act in a valve closing direction as a back pressure. In a shock absorber, it is required to reduce costs while increasing functionality. For example, a mechanism that causes a pressure from a high-pressure chamber to act in a valve closing direction as a back pressure is provided to a damping valve that opens when the piston moves. In addition to this, a mechanism for suppressing the back pressure becoming too high in pressure, and a mechanism for generating a damping force while changing an amount of valve opening from a region at which the piston speed is relatively low are provided. In a case of such a structure, it is conceivable that it will result in high costs. Even in such a structure, reduction in costs is required.

The shock absorber 1 of the present embodiment includes the first damping valve 52 that provides resistance to a flow of the oil fluid from the upper chamber 19 on the upstream side of the first passage 43 to the lower chamber 20 on the downstream side during the extension stroke. Also, the shock absorber 1 includes the back pressure chamber 171 that causes an internal pressure to act on the first damping valve 52 in a valve closing direction during the extension stroke. Also, the shock absorber 1 includes the bottomed cylindrical case member 56 having the opening 78 at one end, the first damping valve 52 disposed in the opening 78, and the back pressure chamber 171 formed therein. Also, the shock absorber 1 includes the second passage 192 that introduces the oil fluid into the back pressure chamber 171 from the upper chamber 19. Also, the shock absorber 1 includes the second damping valve 58 seated on the first seat part 75 formed on the bottom portion 71 of the case member 56, and configured to open due to a pressure of the back pressure chamber 171 to provide resistance to a flow of the oil fluid toward the lower chamber 20. Also, the shock absorber 1 includes the third damping valve 61 seated on the second seat part 76 formed on the bottom portion 71 of the case member 56 to have a diameter larger than that of the first seat part 75, and configured to open with the first damping valve 52 closed in a region at which the piston speed is low.

As described above, the shock absorber 1 includes the back pressure chamber 171 that causes an internal pressure to act in a valve closing direction on the first damping valve 52 that is configured to provide resistance to a flow of the oil fluid from the upper chamber 19 to the lower chamber 20 in the first passage 43. Also, the shock absorber 1 includes the second damping valve 58 that opens due to the pressure in the back pressure chamber 171. Therefore, the back pressure chamber 171 becoming too high in pressure can be suppressed. Also, the shock absorber 1 includes the third damping valve 61 that opens with the first damping valve 52 closed in a region at which the piston speed is low. Therefore, a damping force can be generated while changing an amount of valve opening of the third damping valve 61 from a region at which the piston speed is relatively low.

Then, in the shock absorber 1, the first damping valve 52 is disposed in the opening 78 of the bottomed cylindrical case member 56, and the back pressure chamber 171 is formed inside the case member 56. At the same time, in the shock absorber 1, the first seat part 75 on which the second damping valve 58 is seated, and the second seat part 76 on which the third damping valve 61 is seated are formed on the bottom portion 71 of the case member 56. Therefore, the shock absorber 1 can reduce the number of parts and reduce costs. Also, the shock absorber 1 can reduce an axial length of all these parts, and can minimize a space for all these parts.

The shock absorber 1 of the embodiment includes the partition member 111 provided to partition the inside of the case member 56 into the back pressure chamber 171 and the variable chamber 172. Thereby, volumes of the back pressure chamber 171 and the variable chamber 172 can be made variable by deforming the partition member 111. That is, when the partition member 111 is provided in the case member 56, it is possible to configure the frequency sensitive mechanism 311. Therefore, the shock absorber 1 can make the damping force variable according to the piston frequency while suppressing an increase in cost and an increase in axial length.

In the shock absorber 1 of the embodiment, the passage portion 173 communicating with the variable chamber 172 is formed in the outer cylindrical portion 73 formed on the outer circumferential side of the bottom portion 71 of the case member 56 and having the opening 78. Therefore, the shock absorber 1 can allow the variable chamber 172 to communicate with the outside of the case member 56.

In the shock absorber 1 of the embodiment, the partition member 111 includes the metal ring 112 and the lip 113 formed integrally with the metal ring 112. Therefore, the shock absorber 1 can make volumes of the back pressure chamber 171 and the variable chamber 172 variable by deforming the lip 113 while securing rigidity at the time of being attached to the case member 56 with the metal ring 112.

In the shock absorber 1 of the embodiment, the lip 113 of the partition member 111 constitutes the check valve 175 that restricts a flow in one direction and allows a flow in the other direction between the back pressure chamber 171 and the variable chamber 172. Therefore, the shock absorber 1 can have a frequency sensitive function and a check valve function while suppressing an increase in cost and an increase in axial length.

The shock absorber 1 of the embodiment includes the inner cylindrical portion 72 formed on an inner circumferential side of the bottom portion 71 of the case member 56. Then, the partition member 111 is disposed between the outer cylindrical portion 73 formed on the outer circumferential side of the bottom portion 71 and the inner cylindrical portion 72. Therefore, in the shock absorber 1, the metal ring 112 can be positioned in the radial direction by the outer cylindrical portion 73 or the inner cylindrical portion 72. Therefore, in the shock absorber 1, it is possible to automate sub-assembly of attaching the partition member 111 to the case member 56 using the metal ring 112. As a result, in the shock absorber 1, productivity can be improved and further reduction in cost can be achieved.

In the shock absorber 1 of the embodiment, the partition member 111 is fixed in the case member 56 by press fitting at the metal ring 112. Therefore, the partition member 111 can be assembled to the case member 56 in advance, which then can be assembled to the piston rod 21 as a single part. As a result, the shock absorber 1 can be improved in productivity. For example, it is also possible to automate sub-assembly of press-fitting the partition member 111 into the case member 56 using the metal ring 112. Also, in the shock absorber 1, since the partition member 111 is reliably fixed to the case member 56 by press fitting, there is no concern that the partition member 111 will fall off from the case member 56 in the sub-assembled state, or the like. Also, the shock absorber 1 has a structure in which the lip 113 is supported by the metal ring 112 that is press-fitted into the case member 56 and fixed. Therefore, the shock absorber 1 can stabilize a deformation operation of the lip 113. Therefore, the shock absorber 1 can improve stability of damping force performance.

### INDUSTRIAL APPLICABILITY

According to the above-described aspect of the present invention, it is possible to provide a shock absorber that can reduce costs. Therefore, industrial applicability is significant.

### REFERENCE SIGNS LIST

1 Shock absorber
2 Cylinder
18 Piston
19 Upper chamber (chamber)
20 Lower chamber (chamber)
43 First passage
52 First damping valve
56 Case member
58 Second damping valve
61 Third damping valve
71 Bottom portion
72 Inner cylindrical portion (protruding portion)
73 Outer cylindrical portion (cylindrical portion)
75 First seat part
76 Second seat part
78 Opening
111 Partition member
112 Metal ring
113 Lip
171 Back pressure chamber
172 Variable chamber (separate chamber)
173 Passage portion
175 Check valve
192 Second passage

1. A shock absorber comprising:
a cylinder in which a working fluid is sealed;
a piston fitted in the cylinder and partitioning an inside of the cylinder into two chambers;
a first passage through which a flow of the working fluid occurs due to movement of the piston in one direction;
a first damping valve providing resistance to a flow of the working fluid from a chamber on an upstream side to a chamber on a downstream side of the first passage;
a back pressure chamber causing an internal pressure to act on the first damping valve in a valve closing direction;
a bottomed cylindrical case member having an opening at one end, the first damping valve disposed in the opening, and the back pressure chamber formed therein;
a second passage introducing the working fluid into the back pressure chamber from the chamber on the upstream side;
a second damping valve seated on a first seat part formed on a bottom portion of the case member and configured to open due to a pressure of the back pressure chamber to provide resistance to a flow of the working fluid toward the chamber on the downstream side;
a third damping valve seated on a second seat part formed on the bottom portion of the case member to have a diameter larger than that of the first seat part and configured to open with the first damping valve closed in a region at which a piston speed is low;
a partition member partitioning an inside of the case member into the back pressure chamber and a separate chamber, wherein
a passage portion communicating with the separate chamber is formed in a cylindrical portion formed on an outer circumferential side of the bottom portion and having the opening.

2.-3. (canceled)

4. The shock absorber according to claim 1, wherein the partition member includes a metal ring and a lip formed integrally with the metal ring.

5. The shock absorber according to claim 4, wherein the lip constitutes a check valve configured to restrict a flow in one direction and allow a flow in another direction between the back pressure chamber and the separate chamber.

6. The shock absorber according to claim 1, wherein
a protruding portion is formed in the case member on an inner circumferential side of the bottom portion, and
the partition member is disposed between the protruding portion and the cylindrical portion formed on an outer circumferential side of the bottom portion and having the opening.
